(19) United States
(12) Patent Application Publication
(10) Pub. No.: US 2018/0046254 A1
(43) Pub. Date: Feb. 15, 2018

(54) INFORMATION DISPLAY DEVICE AND INFORMATION DISPLAY METHOD

(71) Applicant: MITSUBISHI ELECTRIC CORPORATION, Tokyo (JP)

(72) Inventors: Aki TAKAYANAGI, Tokyo (JP); Masashi KAMIYA, Tokyo (JP); Yudai NAKAMURA, Tokyo (JP); Masahiro NAITO, Tokyo (JP)

(73) Assignee: MITSUBISHI ELECTRIC CORPORATION, Tokyo (JP)

(21) Appl. No.: 15/550,313

(22) PCT Filed: Mar. 14, 2016
(86) PCT No.: PCT/JP2016/057900

§ 371 Date: Aug. 10, 2017

(30) Foreign Application Priority Data
Apr. 20, 2015 (JP) 2015-085523

(51) Int. Cl. G06F 3/01; G06K 9/00; G06F 3/0482

(52) U.S. Cl. CPC G06F 3/017; G06F 3/0482; G06K 9/00355; G06K 9/00369; G09G 2320/0261

(57) ABSTRACT

An information display device includes a display control unit, a gesture detection unit, a gesture identification unit that makes identification of an operator's gesture based on gesture information and outputs a signal based on a result of the identification, a distance estimation unit that estimates a distance between the operator and a display unit, and an identification function setting unit that sets gestures identifiable by the gesture identification unit so that the number of gestures identifiable by the gesture identification unit when the estimated distance is over a first set distance is smaller than the number of gestures identifiable by the gesture identification unit when the estimated distance is less than or equal to the first set distance.

### TECHNICAL FIELD

The present invention relates to an information display device and an information display method in which a command from an operator (user) is inputted by a gesture made by the operator.

### BACKGROUND ART

Gesture UIs (User Interfaces) are beginning to be employed in recent years as user interfaces of television sets (broadcast receivers), PCs (Personal Computers), car navigation systems, digital signage systems and so forth. The gesture UI enables an operator to operate a device by gesture, such as body motion or body shape of the operator (e.g., hand motion, hand shape, finger motion, finger shape, etc.). For example, with a gesture UI employing the hand pointing and moving a pointer on the screen of a display unit (display) according to a hand motion, when the operator makes a gesture of pointing at a pointer position with a hand, the pointer on the screen is moved according to the gesture.

The gesture UI detects (captures images of) the operator's gesture by using a gesture detection unit (sensor unit) such as an image capturing device like an RGB (Red, Green, Blue) camera or a ToF (Time of Flight) sensor. The gesture UI identifies (determines) the gesture by analyzing image data obtained by capturing images of the operator and outputs a signal representing command content meant by the gesture. However, as the operator gets farther from the gesture detection unit (sensor unit), the size of the operator in the image of each frame generated by the image capturing decreases and the moving amount of a body part by the operator's gesture also decreases. As above, when the operator is situated at a position far from the gesture detection unit, the gesture UI has to identify (determine) the gesture based on the small movement of the body part and output the signal representing the command content indicated by the gesture. Therefore, a problem occurs with the gesture UI in that the gesture is erroneously identified (determined) or the gesture cannot be identified when the operator is far from the gesture detection unit.

Patent Reference 1 proposes an image processing device that sets an operation target region based on the position and the size of a detection object in an image generated by an image capturing device as the gesture detection unit. In the image processing device, by setting the operator's hand or face as the detection object, the ratio between the size of the operation target region that is set and the size of the operator's hand or face included in the operation target region is maintained constant. Accordingly, the operability for the operator improves.

### PRIOR ART REFERENCE

### Patent Reference

Patent Reference 1: Japanese Patent Application Publication No. 2013-257762

### SUMMARY OF THE INVENTION

### Problem to be Solved by the Invention

However, even with each conventional technology described above, as the operator gets farther from the gesture detection unit, the size of the operator in the image of each frame generated by the image capturing decreases, and thus there is a problem in that erroneous gesture identification by the gesture UI becomes likely to occur.

It is therefore an object of the present invention, which has been made to resolve the above-described problem with the conventional technologies, to provide an information display device and an information display method with which the erroneous identification of the operator's gesture is unlikely to occur even when the operator is situated at a position far from the information display device.

### Means for Solving the Problem

An information display device according to the present invention includes a display control unit that makes a display unit display information, a gesture detection unit that generates gesture information based on a gesture made by an operator, a gesture identification unit that makes identification of the gesture based on the gesture information generated by the gesture detection unit and outputs a signal based on a result of the identification, a distance estimation unit that estimates distance between the operator and the display unit, and an identification function setting unit that stores a first set distance previously determined and sets gestures identifiable by the gesture identification unit so that the number of gestures identifiable by the gesture identification unit when the distance is over the first set distance is smaller than the number of gestures identifiable by the gesture identification unit when the distance is less than or equal to the first set distance.

An information display method according to the present invention is an information display method executed by an information display device that makes a display unit display information, including a gesture detection step of generating gesture information based on a gesture made by an operator, a gesture identification step of making identification of the gesture based on the gesture information generated in the gesture detection step and generating a signal based on a result of the identification, a distance estimation step of estimating distance between the operator and the display unit, and an identification function setting step of setting gestures identifiable in the gesture identification step so that the number of gestures identifiable in the gesture identification step when the distance is over a first set distance predetermined is smaller than the number of gestures identifiable in the gesture identification step when the distance is less than or equal to the first set distance.

### Effects of the Invention

In the present invention, the identifiable gestures are set so that the number of the identifiable gestures decreases when the operator is situated at a position far from the display unit of the information display device. As above, by the present invention, when the operator is situated at a position far from the display unit, an erroneous identification of the operator's gesture can be made unlikely to occur by excluding gestures with a small body movement from the identifiable gestures, for example.

### BRIEF DESCRIPTION OF THE DRAWINGS

FIG. 1 is a schematic diagram showing usage status of an information display device according to a first embodiment of the present invention.

FIG. 2 is a block diagram schematically showing the configuration of the information display device according to the first embodiment.

FIG. 3 is a diagram showing an example of an image acquired by the information display device according to the first embodiment by capturing an image of an operator.

FIG. 4 is a schematic diagram showing operational states of the info/notion display device according to the first embodiment.

FIG. 5 is a diagram showing an example of an image displayed on a display unit of the information display device according to the first embodiment.

FIG. 6 is a diagram showing another example of the image displayed on the display unit of the information display device according to the first embodiment.

FIG. 7 is a diagram showing another example of the image displayed on the display unit of the information display device according to the first embodiment.

FIG. 8 is a diagram showing another example of the image displayed on the display unit of the information display device according to the first embodiment.

FIG. 9 is a diagram showing another example of the image displayed on the display unit of the information display device according to the first embodiment.

FIGS. 10(a) and 10(b) are diagrams showing transition of the image displayed on the display unit of the information display device according to the first embodiment (in a case where the operator is situated at a position close to the display unit).

FIGS. 11(a) and 11(b) are diagrams showing transition of the image displayed on the display unit of the information display device according to the first embodiment (in a case where the operator is situated at a position far from the display unit).

FIGS. 12(a) to 12(c) are schematic diagrams showing usage status of the information display device according to the first embodiment.

FIG. 13 is a flowchart showing an initial setting of the information display device according to the first embodiment.

FIG. 14 is a flowchart showing the operation of the information display device according to the first embodiment.

FIG. 15 is a flowchart showing the operation of an information display device according to a second embodiment of the present invention.

FIG. 16 is a schematic diagram showing usage status of an information display device according to a third embodiment of the present invention.

FIG. 17 is a block diagram schematically showing the configuration of the information display device according to the third embodiment.

FIG. 18 is a schematic diagram showing usage status of an information display device according to a fourth embodiment of the present invention.

FIG. 19 is a block diagram schematically showing the configuration of the information display device according to the fourth embodiment.

FIG. 20 is a block diagram schematically showing the configuration of an information display device according to a fifth embodiment of the present invention.

FIG. 21 is a block diagram schematically showing the configuration of an information display device according to a modification of the fifth embodiment.

FIG. 22 is a flowchart showing the operation of the information display device according to the fifth embodiment.

FIG. 23 is a block diagram schematically showing the configuration of an information display device according to a sixth embodiment of the present invention.

FIG. 24 is a flowchart showing the operation of the information display device according to the sixth embodiment.

FIG. 25 is a schematic diagram showing usage status of an information display device according to a seventh embodiment of the present invention.

FIG. 26 is a block diagram schematically showing the configuration of the information display device according to the seventh embodiment.

FIG. 27 is a flowchart showing the operation of the information display device according to the seventh embodiment.

FIG. 28 is a hardware configuration diagram showing the configuration of a modification of the information display devices according to the first to seventh embodiments.

### MODE FOR CARRYING OUT THE INVENTION

### <1> First Embodiment

### <1-1> Configuration

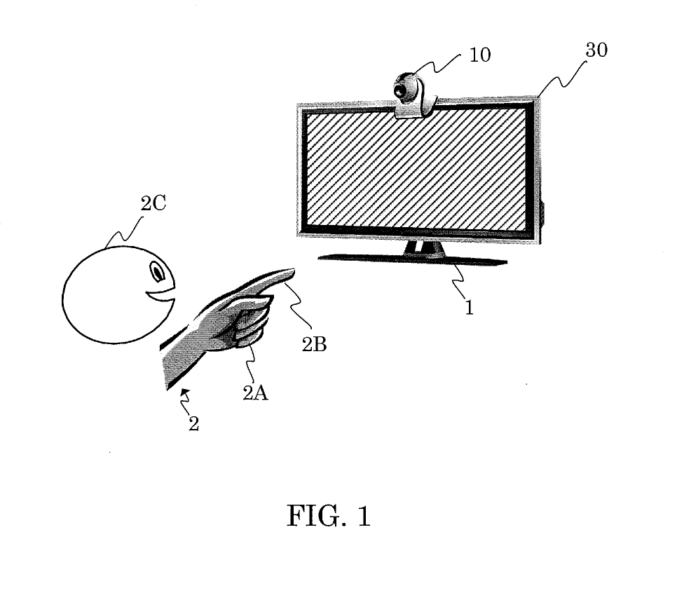

FIG. 1 is a schematic diagram showing usage status of an information display device 1 according to a first embodiment of the present invention. As shown in FIG. 1, the information display device 1 includes a display unit 30 as a display and a gesture detection unit (sensor unit) 10 as an image capturing unit such as an image capturing device (camera) or a ToF. The information display device 1 includes a gesture UI that operates the information display device 1 according to a gesture made by an operator (user) 2. In the first embodiment, the gesture detection unit 10 is attached to a top part of a main body of the information display device 1. However, the gesture detection unit 10 may be stored in the main body of the information display device 1 or provided in the vicinity of the main body of the information display device 1. In cases where the information display device 1 holds information indicating the positional relationship between the gesture detection unit 10 and the main body of the information display device 1, the gesture detection unit 10 may be provided at a position apart from the main body of the information display device 1. The operator 2 inputs command information to the information display device 1 by a gesture as a motion and shape of the operator 2's body (e.g., predetermined motion and pose of a hand 2A and a finger 2B, expression of the face 2C, or the like). For example, the operator 2's motion of moving the hand 2A to right direction, motion of moving the hand 2A to left direction, motion of moving the hand 2A to the upward direction, motion of moving the hand 2A to the downward direction, motion of pointing with the finger 2B, motion of forming a peace sign with the hand 2A and fingers 2B, etc. can be taken as examples of the gesture.

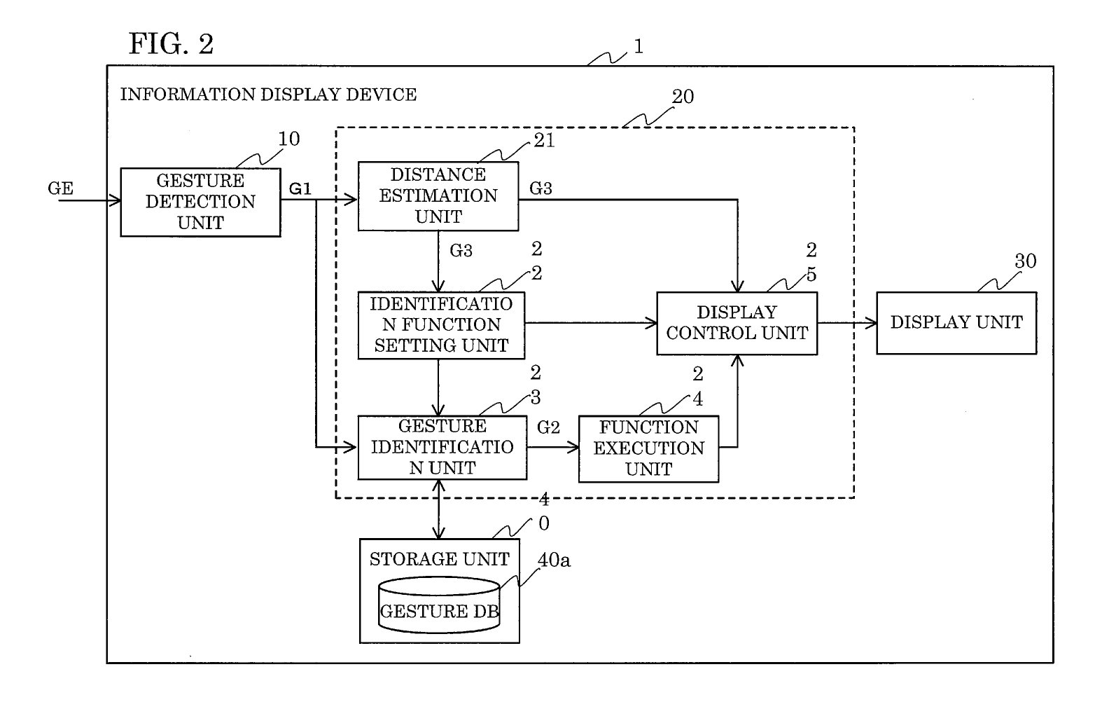

FIG. 2 is a block diagram schematically showing the configuration of the information display device 1 according to the first embodiment. The information display device 1 is a device capable of executing an information display method according to the first embodiment. As shown in FIG. 2, the information display device 1 includes the gesture detection unit 10 as the image capturing unit and a control unit 20. The information display device 1 may further include the display unit 30 as the display and a storage unit 40 such as a memory. The control unit 20 includes a distance estimation unit 21, an identification function setting unit 22, a gesture identification unit (gesture judgment unit) 23, and a display control unit 25. The information display device 1 may further include a function execution unit 24.

The gesture detection unit 10 generates gesture information G1 based on a gesture GE performed by the operator 2. For example, the gesture detection unit 10 captures images of the operator 2's gesture GE and generates the gesture information G1 including image data corresponding to the gesture GE. The image data is, for example, still image data of a plurality of frames arranged in the order of time or video image data. Incidentally, while a case where the gesture detection unit 10 is an image capturing unit is described in the first embodiment, the gesture detection unit 10 may be a different type of device such as an operating device (described in a fourth embodiment) attached to a part of the operator 2's body as long as the device is capable of generating gesture information corresponding to the operator 2's gesture.

The gesture identification unit 23 makes the identification (determination) of the gesture based on the gesture information G1 generated by the gesture detection unit 10 and outputs a signal G2 based on the result of the identification. Here, the identification of the gesture means a process of identifying or determining what kind of command content is indicated by the gesture made by the operator 2.

The gesture identification unit 23 detects a motion pattern of the gesture from the image data generated by the gesture detection unit 10. In this case, the gesture identification unit 23 detects the motion pattern of the gesture by analyzing displacement of a detection region including a part of the operator 2's body based on still image data of a plurality of frames arranged in the order of time or video image data.

In cases where the gesture detection unit 10 is a stereo camera capable of acquiring information on the depth of the subject, the gesture identification unit 23 detects the motion pattern of the gesture by estimating the three-dimensional position of the detection region including a part of the operator 2's body.

In cases where the gesture detection unit 10 is a monocular camera having one lens, the gesture identification unit 23 detects the motion pattern of the gesture based on a distance D0 estimated by the distance estimation unit 21 and the image data of the detection region.

The storage unit 40 stores a gesture database (DB) 40a in which each of a plurality of reference gestures is associated with command content corresponding to the plurality of reference gesture. The gesture identification unit 23 compares the detected motion pattern with each of the plurality of reference gestures stored as the gesture DB 40a and determines a reference gesture corresponding to the detected motion pattern from the stored the plurality of reference gestures. The gesture identification unit 23 judges that the command content associated with the determined reference gesture is the command content by the operator 2. Incidentally, the gestures and the command contents stored in the storage unit 40 as the gesture DB 40a have been stored in the storage unit 40 previously. It is also possible to allow the operator 2 to determine the gestures and the command contents corresponding to the gestures and store the determined gestures and command contents in the storage unit 40 as the gesture DB 40a.

The distance estimation unit 21 estimates the distance D0 between the operator 2 and the gesture detection unit 10 (or the display unit 30) based on the gesture information G1 outputted from the gesture detection unit 10, and supplies distance information G3 representing the distance D0 to the identification function setting unit 22 and the display control unit 25. As shown in FIG. 1, in the first embodiment, the distance between the operator 2 and the display unit 30 equals the distance between the operator 2 and the gesture detection unit 10, or has a certain relationship with the distance between the operator 2 and the gesture detection unit 10, and is calculable. For example, the distance estimation unit 21 detects a particular part of the operator 2's body included in the image data as the detection region and estimates (calculates) the distance D0 between the operator 2 and the gesture detection unit 10 (or the display unit 30) based on the size of the detection region in the image of each frame. Incidentally, the distance estimation unit 21 may calculate the distance D0 by a different method.

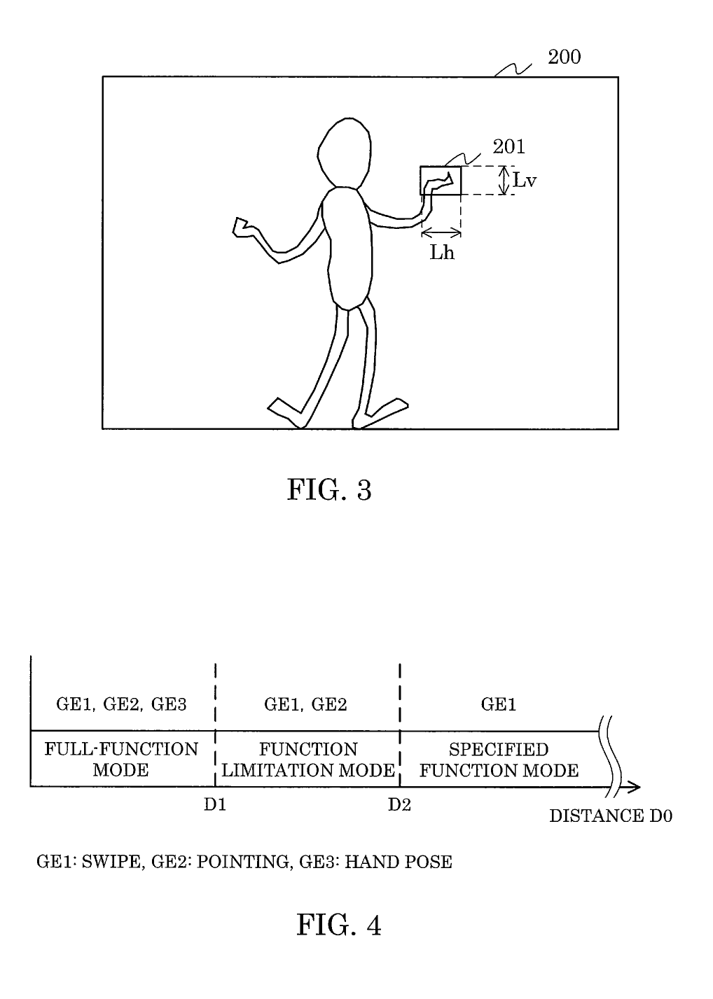

FIG. 3 is a diagram showing an example of an image 200 acquired by the gesture detection unit 10 of the information display device 1 according to the first embodiment by capturing an image of the operator 2. The distance estimation unit 21 detects the hand 2A of the operator 2 included in the image 200 as a detection region 201. Here, the distance estimation unit 21 detects the operator's skin color from information on colors included in the image and specifies a particular part of the operator 2's body as the detection region. In cases where the detection region is the face, it is also possible to judge the region of the entire face after judging parts (eyes, nose, mouth, etc.) of the face. The distance estimation unit 21 may employ a different method, such as judging the face by a method of setting a search window in the image and judging whether each region is a face region or not by use of a classifier. For example, it is possible to set both the face and the hand 2A of the operator 2 as the detection regions. The distance estimation unit 21 estimates (calculates) the distance D0 between the operator 2 and the gesture detection unit 10 (or the display unit 30) based on the size of the detection region 201 in the image 200.

In the estimation of the distance D0 between the operator 2 and the gesture detection unit 10 (or the display unit 30) by the distance estimation unit 21, there are cases where the distance D0 is estimated and cases where it is judged whether the operator 2 is situated at a position closer to the display unit 30 than a predetermined reference distance or at a position farther from the display unit 30 than the predetermined reference distance.

In cases where the distance D0 between the operator 2 and the gesture detection unit 10 (or the display unit 30) is estimated (calculated), the distance estimation unit 21 previously stores correlation data between the size of the detection region 201 in the image 200 and the distance D0. The distance estimation unit 21 estimates (calculates) the distance D0 based on the correlation data and the size of the detection region 201 in the generated image 200. The size of the detection region 201 can be derived from the area of the detection region 201 or at least one of the vertical length Lv and the horizontal length Lh of the detection region 201.

In cases of judging whether the operator 2 is situated at a position closer to the display unit 30 than the predetermined reference distance or at a position farther from the display unit 30 than the predetermined reference distance, the distance estimation unit 21 previously stores a reference position, as a position where the operator 2 is supposed to perform a gesture, and the size of the detection region 201 at the reference position in the image 200 as the correlation data. The distance estimation unit 21 judges whether the operator 2 is situated at a position closer than the reference position or at a position farther than the reference position based on the correlation data and the size of the detection region 201 in the generated image 200. In this case, the number of calculations by the control unit 20 is reduced.

The identification function setting unit 22 stores a predetermined first set distance D1, and sets gestures identifiable by the gesture identification unit 23 so that the number of gestures identifiable by the gesture identification unit 23 when the distance D0 is over the first set distance D1 is smaller than the number of gestures identifiable by the gesture identification unit 23 when the distance D0 is less than or equal to the first set distance D1. The first set distance D1 is previously set when the use of the information display device 1 is started.

The identification function setting unit 22 does not limit the gestures identifiable by the gesture identification unit 23 when the distance D0 is less than or equal to the first set distance D1. In this case, the operational state of the information display device 1 is referred to as a full-function mode. The identification function setting unit 22 notifies the gesture identification unit 23 of the identifiable gestures and notifies the display control unit 25 of the operational state of the information display device 1.

The identification function setting unit 22 limits the gestures identifiable by the gesture identification unit 23 when the distance D0 is greater than the first set distance D1 and less than or equal to a second set distance D2. Here, the limited identifiable gestures are gestures for functions of a high frequency of use by the operator 2. In this case, the operational state of the information display device 1 is referred to as a limited function mode.

The identification function setting unit 22 further limits the gestures identifiable by the gesture identification unit 23 when the distance D0 is greater than the second set distance D2. Here, the further limited identifiable gestures are gestures for functions of a still higher frequency of use by the operator 2. In this case, the operational state of the information display device 1 is referred to as a specified function mode.

The distance D2 used by the identification function setting unit 22 as a reference is assumed to be a distance at which the gesture recognition by the gesture identification unit 23 is difficult. This distance D2 is set based on one or more or all of sensor performance such as the resolution of the camera used for the gesture detection unit 10, spectral filter information, lens performance such as MTF (Modulation Transfer Function), information on illumination environment such as color and illuminance of illuminating light, and size and color information on the detection object.

The function execution unit 24 executes a function based on the signal G2 outputted from the gesture identification unit 23. Further, the function execution unit 24 notifies the display control unit 25 of the result of executing the function.

The display control unit 25 controls the display operation of the display unit 30. For example, the display control unit 25 generates an operation menu and makes the display unit 30 display the operation menu. The display control unit 25 sets display layout and display content on the display unit 30 based on which of the full-function mode, the limited function mode or the specified function mode the operational state set by the identification function setting unit 22 is. Further, the display control unit 25 may adjust sizes of characters, icons and a pointer displayed on the display unit 30 based on the distance D0 estimated (calculated) by the distance estimation unit 21. For example, the display control unit 25 decreases the sizes of the displayed characters, icons and pointer when the distance D0 is short and increases the sizes of the displayed characters, icons and pointer with the increase in the distance D0. With such adjustment, visibility of icons, characters, pointer, etc. is maintained. Furthermore, the display control unit 25 makes the display unit 30 display the result supplied from the function execution unit 24.

### <1-2> Operation

FIG. 4 is a schematic diagram showing the operational states of the information display device 1 according to the first embodiment. FIG. 4 shows relationship among the distance D0 between the operator 2 and the gesture detection unit 10 (or the display unit 30), types of gestures identifiable (usable) by the information display device 1 when the operator 2 operates the information display device 1 by gesture, and the state of the information display device 1. In the example of FIG. 4, the gestures identifiable (usable) when the operator 2 operates the information display device 1 by gesture are classified into three types of gestures GE1, GE2 and GE3. The three types of gestures differ from each other in the easiness of the identification by the information display device 1. For example, the first type of gesture GE1 is a swipe as the operator 2's motion of waving a hand, the second type of gesture GE2 is pointing as the operator 2's motion of pointing a direction or position with a finger, and the third type of gesture GE3 is the operator 2's pose of making a particular shape with a hand. The first type of gesture GE1 is a gesture that can be judged just by the moving direction of a particular part of the body such as the hand 2A. In contrast, the third type of gesture GE3 cannot be judged just by the moving direction of a particular part of the body such as the hand 2A, and cannot be judged without analyzing displacement of the particular part of the body. As above, the second type of gesture GE2 is a gesture that is slightly hard to recognize, and the third type of gesture GE3 is a gesture that is the most hard to recognize.

When the distance D0 is less than or equal to the first set distance D1 (i.e., when the information display device 1 is in the full-function mode), the operator 2 can use any type of gesture GE1, GE2 or GE3 for operating the information display device 1 by gesture. When the distance D0 is greater than the first set distance D1 and less than or equal to the second set distance D2 (i.e., when the state of the information display device 1 is the limited function mode), the operator 2 can use the first type of gesture GE1 and the second type of gesture GE2 but cannot use the third type of gesture GE3. When the distance D0 is over the second set distance D2 (i.e., when the state of the information display device 1 is the specified function mode), the operator 2 can use the first type of gesture GE1 but cannot use the second type of gesture GE2 or the third type of gesture GE3.

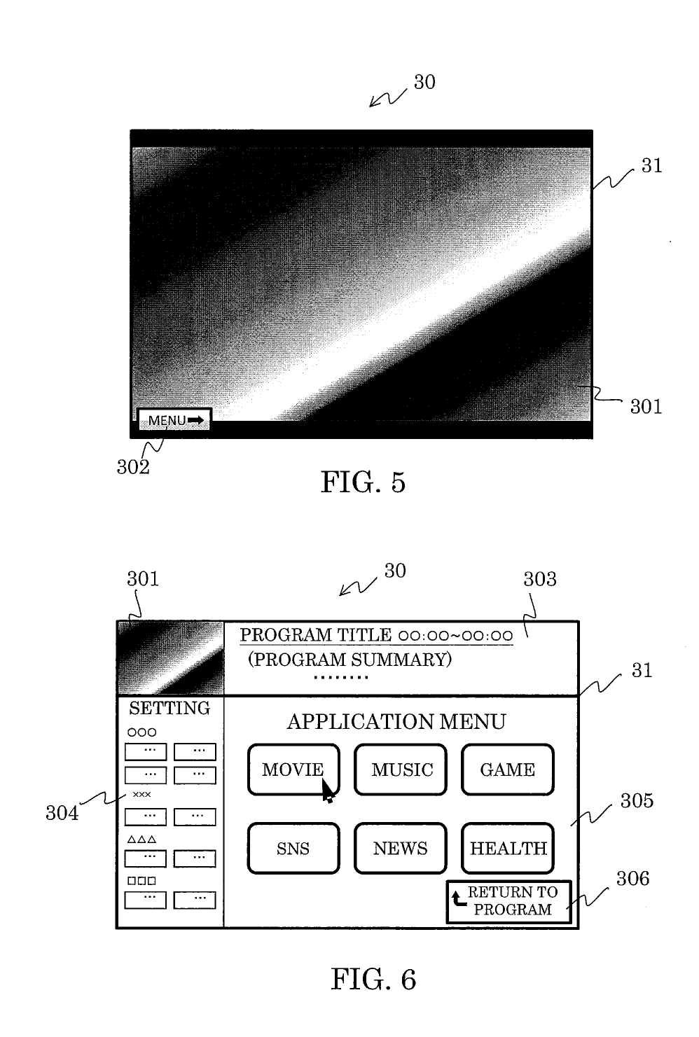

FIG. 5 is a diagram showing an example of the image displayed on a screen 31 of the display unit 30 of the information display device 1 according to the first embodiment. FIG. 5 shows an example of the display content when the distance D0 between the operator 2 and the gesture detection unit 10 (or the display unit 30) is less than or equal to the first set distance D1. In this case, currently viewed program images 301 based on video content are displayed on the entire screen 31 of the display unit 30. Further, a “MENU” icon 302 is displayed in a lower left part of the screen 31. Here, the display shown in FIG. 5 shifts to display content including an operation menu (FIG. 6) when the information display device 1 identifies a predetermined gesture performed by the operator 2 (gesture as a command to shift to the display content including the operation menu) or when the operator 2 performs an operation for selecting the “MENU” icon 302.

FIG. 6 is a diagram showing another example of the image displayed on the screen 31 of the display unit 30 of the information display device 1 according to the first embodiment. FIG. 6 shows an example of the display content when the distance D0 between the operator 2 and the gesture detection unit 10 (or the display unit 30) is less than or equal to the first set distance D1. FIG. 6 shows the display content after shifting from the display content of FIG. 5. In FIG. 6, the screen 31 is divided into four regions. In an upper left region of the screen 31, the currently viewed program images 301 based on video content are displayed. In an upper right region of the screen 31, content information 303 indicating information on the currently viewed program images 301 is displayed. In a lower left region of the screen 31, content setting information 304 as an operation menu is displayed. In a central lower right region of the screen 31, application menu information 305 as an operation menu is displayed. The content setting information 304 includes operation information regarding the currently viewed program images 301, that is, information on channel switching, volume control, recording/playback, image quality/tone control, communication method, and so forth. The application menu information 305 indicates information including icons for making a selection from applications the information display device 1 has. A “RETURN TO PROGRAM” icon 306 is an icon for shifting from the display content of FIG. 6 to the display content of FIG. 5.

When the distance D0 between the operator 2 and the gesture detection unit 10 (or the display unit 30) is less than or equal to the first set distance D1, the information display device 1 is in the full-function mode. The content setting information 304 and the application menu information 305, as the operation menus shown in FIG. 6, are information regarding functions that the operator 2 can operate in the full-function mode.

The icons, characters and pointer displayed on the screen 31 of the display unit 30 can be configured so as be small in size when the distance D0 is short and increase in size with the increase in the distance D0. This configuration allows the operator 2 to recognize that the information display device 1 currently grasps the distance between the operator 2 and the information display device 1. In other words, the fact that the information display device 1 currently recognizes the distance D0 can be fed back to the operator 2 through the sizes of the icons, characters, pointer, etc.

Incidentally, optimum sizes of the icons, characters and pointer on the screen 31 have previously been set on the information display device 1. Thus, settings have been made on the information display device 1 so that changing these sizes will not cause a change impairing visibility such as collapsed layout of multiple pieces of information on the screen 31 or an icon, character or pointer sticking out from the display region on the screen 31.

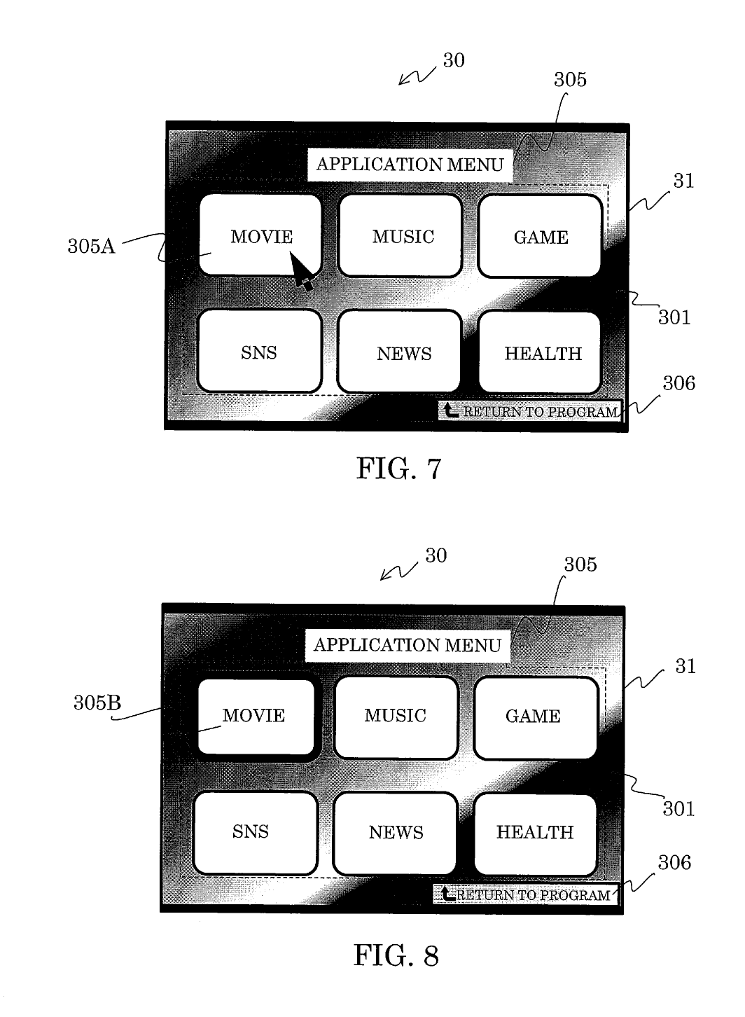

FIG. 7 is a diagram showing another example of the image displayed on the screen 31 of the display unit 30 of the information display device 1 according to the first embodiment. FIG. 7 shows an example of the display when the distance D0 is greater than the first set distance D1 and less than or equal to the second set distance D2. In this case, the region of the screen 31 is not divided. The currently viewed program images 301 based on video content are displayed in the entire region of the screen 31 as background images. The application menu information 305 is displayed in the entire region of the screen 31 on the currently viewed program images 301 displayed as the background.

When the distance D0 is greater than the first set distance D1 and less than or equal to the second set distance D2, the information display device 1 is in the function limitation mode. In the function limitation mode, the functions the operator 2 can operate by gesture are limited to functions of a high frequency of use. The operation information regarding the currently viewed program images 301 is about functions of a low frequency of use by the operator 2. Thus, the content setting information 304 shown in FIG. 6 is not displayed in the function limitation mode as shown in FIG. 7. Further, the content information 303 shown in FIG. 6 is also not displayed in the function limitation mode as shown in FIG. 7 since the content information 303 is not necessarily information of a high frequency of use by the operator 2. Incidentally, the “MOVIE” icon 305A in FIG. 7 is an icon for making the information display device 1 display video content of a movie. FIG. 7 shows a state in which the “MOVIE” icon 305A has been selected with an arrow as a pointer.

As above, in the function limitation mode, information of a low frequency of use by the operator 2 is not displayed on the display unit 30 and the application menu information 305 of a high frequency of use by the operator 2 is displayed large on the entire screen 31 of the display unit 30. Thus, the operator 2 can visually recognize the display content on the display unit 30 even when the operator 2 is far from the display unit 30. Further, since information of a high frequency of use is displayed, operability of the information display device 1 can be maintained when the operator 2 operates the information display device 1.

Incidentally, the display content on the display unit 30 in the function limitation mode is not limited to the application menu information 305. For example, the operator 2 may be allowed to previously select items to be used frequently and assign ranks to the selected items, and the information display device 1 may determine the display content on the display unit 30 based on information on the ranks.

It is also possible for the information display device 1 to count operation items used in gestures by the operator 2, store the result of the counting, and thereby determine the content displayed in the function limitation mode.

FIG. 8 is a diagram showing another example of the image displayed on the screen 31 of the display unit 30 of the information display device 1 according to the first embodiment. The “MOVIE” icon 305B in the selected state in FIG. 8 is displayed with a thick frame instead of being selected with the pointer (arrow). As in this example, the display of the selected icon can be changed depending on the distance D0. It is also possible to employ a configuration in which the size of the “MOVIE” icon 305A (305B) or other icons, characters, etc. included in the application menu information 305 is changed depending on the distance D0.

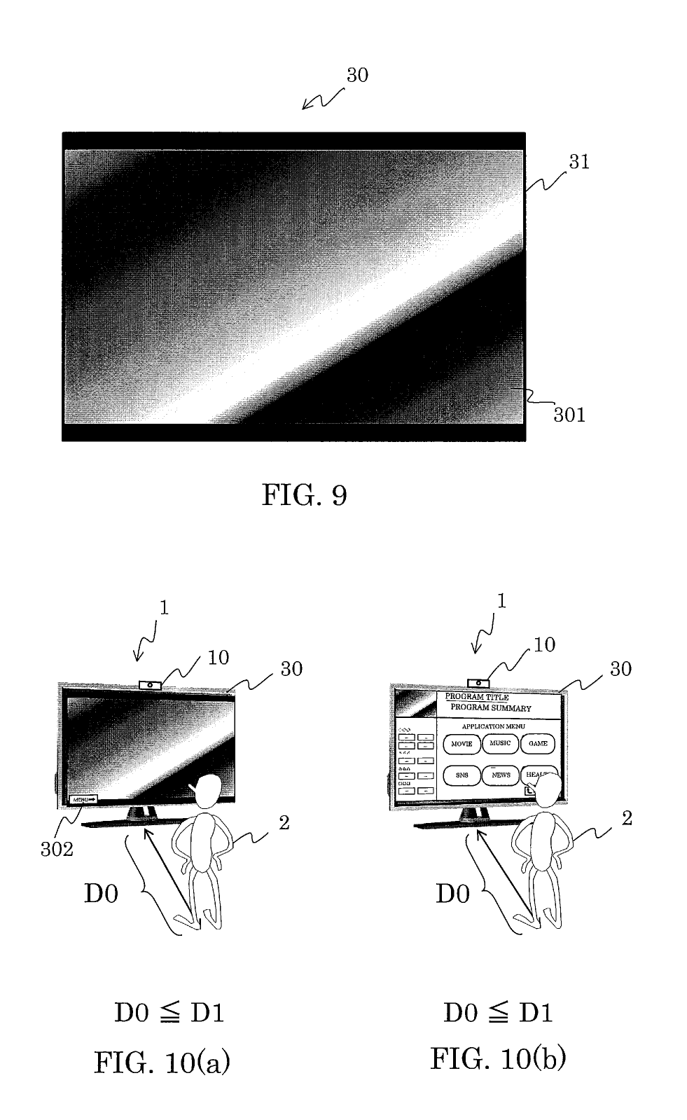

FIG. 9 is a diagram showing another example of the image displayed on the screen 31 of the display unit 30 of the information display device 1 according to the first embodiment. FIG. 9 shows an example of the image displayed on the screen 31 of the display unit 30 when the distance D0 is over the second set distance D2. In the example shown in FIG. 9, the currently viewed program images 301 based on video content are displayed on the entire screen 31 of the display unit 30.

When the distance D0 is over the second set distance D2, the information display device 1 is in the specified function mode. In the specified function mode, the functions that the operator 2 can operate by gesture are limited to functions of a still higher frequency of use, such as channel switching, volume change, etc. in regard to the video content currently viewed by the operator 2. Thus, in the specified function mode, the “MENU” icon 302 (FIG. 5) for shifting to the display content including the operation menu is not displayed on the screen 31 of the display unit 30. As above, the functions of the information display device 1 are limited to functions of a high frequency of use by the operator 2 and information of a low frequency of use by the operator 2 is not displayed on the display unit 30. As explained above, even when the operator 2 is situated still farther from the display unit 30, unnecessary information is not displayed and thus it is possible to avoid a situation in which it is hard for the operator to visually recognize the display content on the display unit 30.

FIGS. 10(a) and 10(b) are diagrams showing transition of the display content by the information display device 1 according to the first embodiment. FIGS. 10(a) and 10(b) show the transition of the display content on the display unit 30 of the information display device 1 when the distance D0 between the operator 2 and the gesture detection unit 10 (or the display unit 30) is less than or equal to the first set distance D1. The display content on the display unit 30 in FIG. 10(a) is identical with the display content on the display unit 30 shown in FIG. 5. The display content on the display unit 30 shown in FIG. 10(b) is identical with the display content on the display unit 30 shown in FIG. 6. When the operator 2 selects the “MENU” icon 302 on the display unit 30 in FIG. 10(a) by making a gesture, the display content on the display unit 30 shifts from the display content in FIG. 10(a) to the display content in FIG. 10(b). When the operator 2 selects the “RETURN TO PROGRAM” icon 306 (FIG. 6) by making a gesture, the display content on the display unit 30 shown in FIG. 10(b) shifts to the display content on the display unit 30 shown in FIG. 10(a).

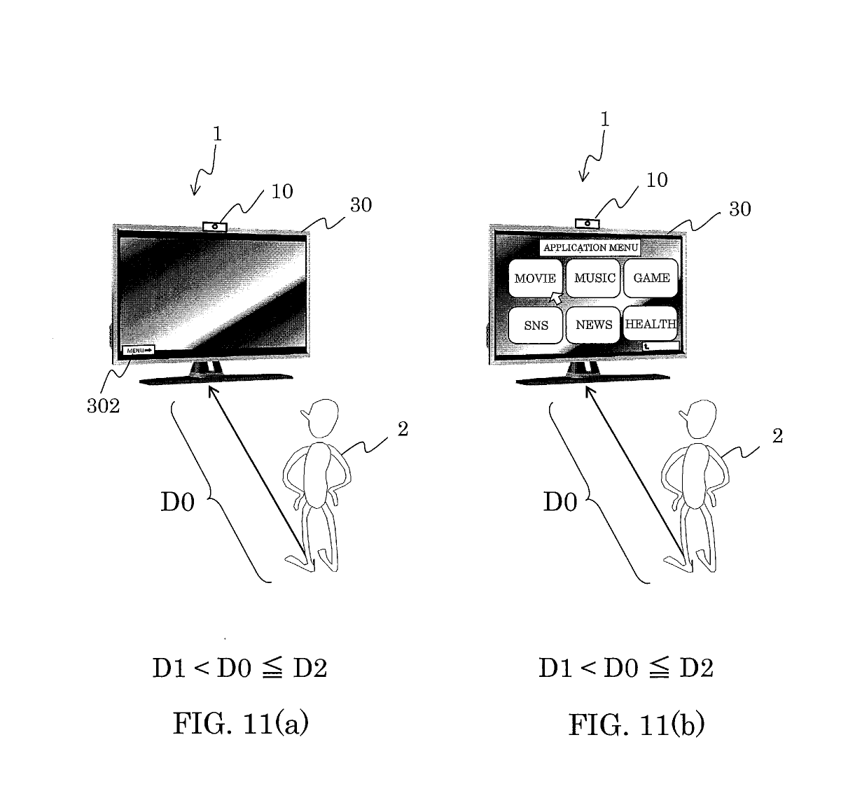

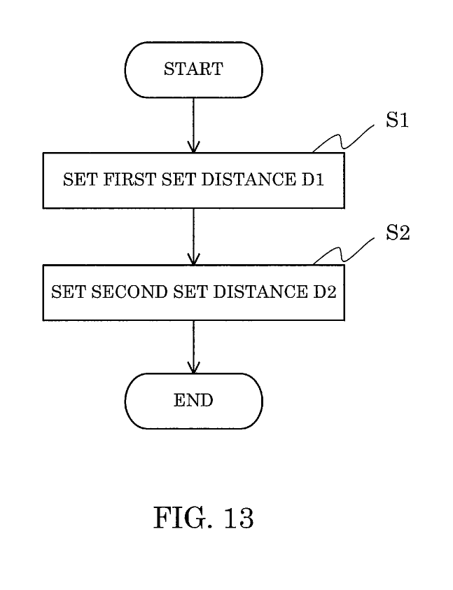

FIGS. 11(a) and 11(b) are diagrams showing transition of the display content by the information display device 1 according to the first embodiment. FIGS. 11(a) and 11(b) show the transition of the display content on the display unit 30 of the information display device 1 when the distance D0 between the operator 2 and the gesture detection unit 10 (or the display unit 30) is greater than the first set distance D1 and less than or equal to the second set distance D2. The display content on the display unit 30 in FIG. 11(a) is identical with the display content on the display unit 30 shown in FIG. 5. The display content on the display unit 30 shown in FIG. 11(b) is identical with the display content on the display unit 30 shown in FIG. 7. When the operator 2 selects the “MENU” icon 302 shown in FIG. 5 by making a gesture, the display content on the display unit 30 shown in FIG. 11(a) shifts to the display content on the display unit 30 shown in FIG. 11(b). When the operator 2 selects the “RETURN TO PROGRAM” icon 306 shown in FIG. 7 by making a gesture, the display content on the display unit 30 shown in FIG. 13(b) shifts to the display content on the display unit 30 shown in FIG. 11(a).

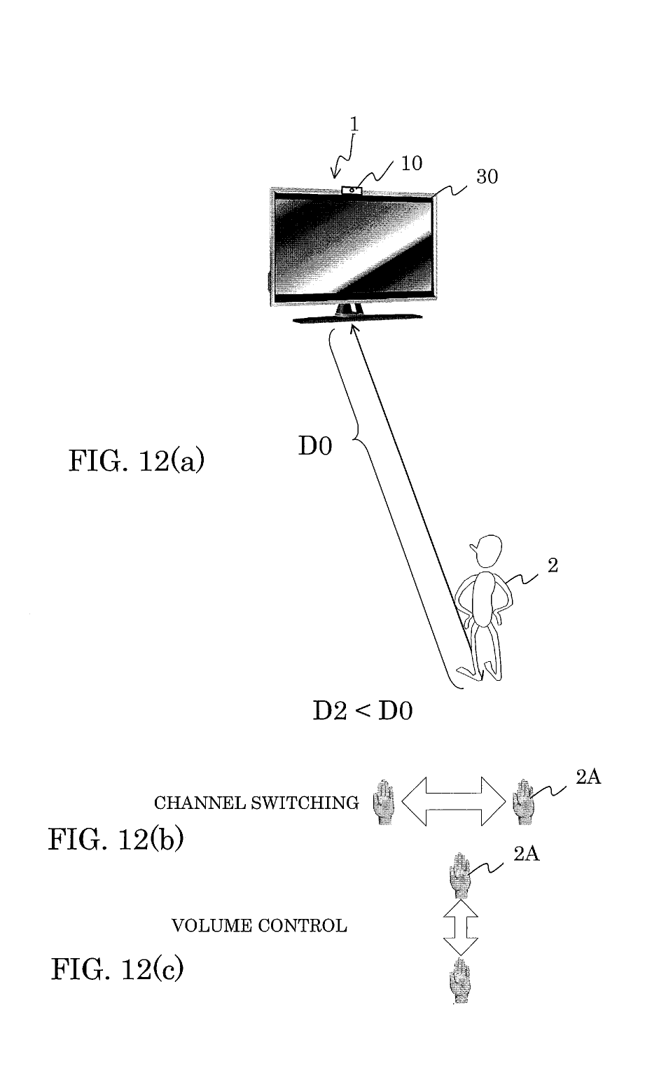

FIGS. 12(a) to 12(c) are schematic diagrams showing usage status of the information display device 1 according to the first embodiment. FIG. 12(a) shows the display content on the display unit 30 of the information display device 1 when the distance D0 between the operator 2 and the gesture detection unit 10 (or the display unit 30) is over the second set distance D2. FIGS. 12(b) and 12(c) show an example of gestures made by the operator 2. The display content on the display unit 30 in FIG. 12(a) is identical with the display content on the display unit 30 in FIG. 9. As shown in FIG. 11(b), to switch the channel, the operator 2 performs a left/right swipe (moves the hand 2A to the left or right in an arrow direction). To adjust the sound volume, the operator 2 performs an up/down swipe (moves the hand 2A upward or downward in an arrow direction).

As above, it becomes possible for the operator 2 to operate the functions of a high frequency of use, channel switching and volume control, by just making a gesture without using an operation menu displayed on the display unit 30. Further, the swipe, as the gesture used in this case, is a gesture easily identified by the information display device 1. Thus, even when the distance between the operator 2 and the information display device 1 is long, the possibility of erroneous identification by the information display device 1 can be reduced.

Incidentally, when the distance D0 is over the second set distance D2, the functions the operator 2 can operate are not limited to channel switching and volume control. However, the functions the operator 2 can operate are desired to be not those identified by the displacement of the operator 2's particular body part such as the hand 2A but those identified by the moving direction.

FIG. 13 is a flowchart showing an initial setting of the information display device 1 according to the first embodiment. The information display device 1 sets the first set distance D1 (step S1). The information display device 1 captures an image of the hand 2A, the fingers 2B, the face 2C, etc. of the operator 2 situated at a position the first set distance D1 from the gesture detection unit 10 (or the display unit 30) by use of the gesture detection unit 10 and stores the sizes of the hand 2A, the fingers 2B, the face 2C, etc. included in the captured image. Here, the data the information display device 1 stores are the area, the vertical length Lv, the horizontal length Lh, etc. of each of the detection regions, when the hand 2A, the fingers 2B and the face 2C are determined as the detection regions as shown as the detection region 201 in FIG. 3. Subsequently, the information display device 1 sets the second set distance D2 (step S2). Similarly to the step S1, the information display device 1 captures an image of the operator 2 situated at a position the second set distance D2 from the gesture detection unit 10 (or the display unit 30) and stores the area of the detection region and the like.

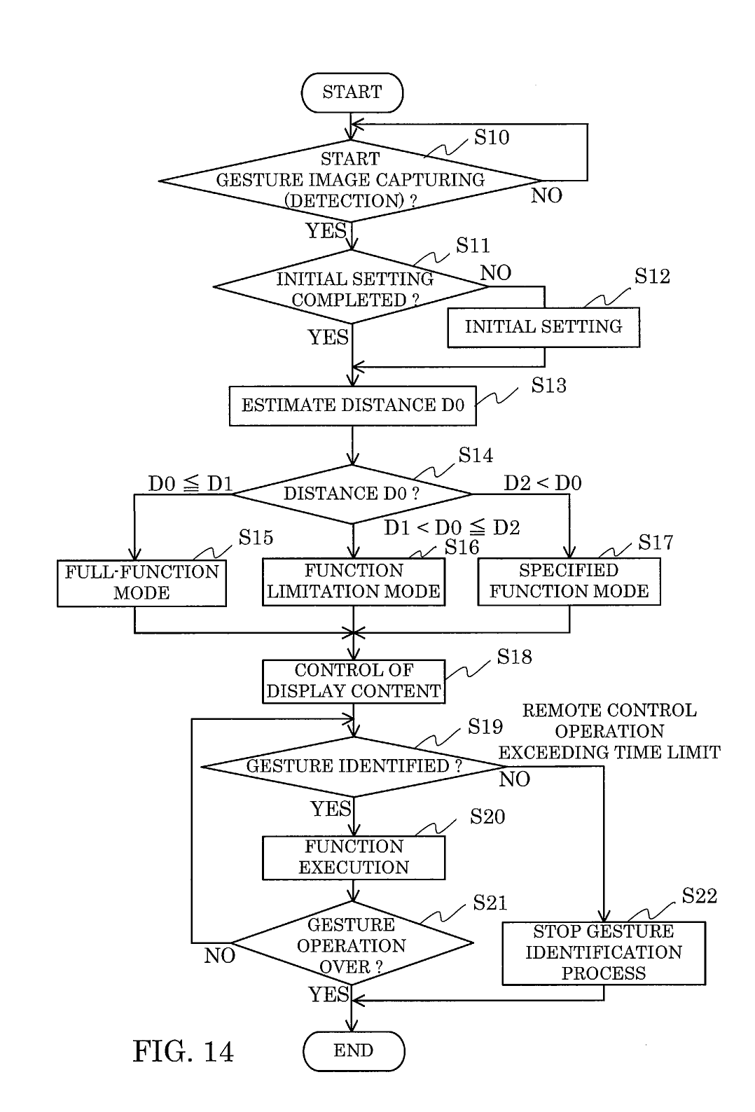

FIG. 14 is a flowchart showing the operation of the information display device 1 according to the first embodiment. The gesture detection unit 10 starts the gesture image capturing (detection) triggered by a predetermined gesture performed by the operator 2 (step S10). The predetermined gesture may be either a pose by the hand 2A or a motion by the hand 2A. The gesture detection unit 10 captures images of the operator 2's gesture and generates image data. Incidentally, while it is assumed in the following explanation that only the operator is image-captured in the generated image data, the present invention is not restricted to this example. The present invention is applicable also to cases where multiple people are included in the image data. In cases where multiple people are included in the image data, it is possible to employ a method of carrying out the gesture recognition for a person whose predetermined body part is detected first among the people or a method of carrying out the gesture recognition for all of the people, for example.

Subsequently, the information display device 1 judges whether the initial setting shown in FIG. 13, that is, the setting of the first set distance D1 and the second set distance D2 (steps S1 and S2), has been completed (step S11). If the initial setting has not been made, the information display device 1 makes the initial setting shown in FIG. 13 (step S12).

Subsequently, the distance estimation unit 21 estimates the distance D0 between the operator 2 and the gesture detection unit 10 (or the display unit 30) (step S13). The information display device 1 advances the process to step S15 if the distance D0 is less than or equal to the first set distance D1, advances the process to step S16 if the distance D0 is greater than the first set distance D1 and less than or equal to the second set distance D2, or advances the process to step S17 if the distance D0 is over the second set distance D2 (step S14).

In the case where the distance D0 is less than or equal to the first set distance D1, the identification function setting unit 22 sets the operational state of the information display device 1 in the full-function mode (step S15). In the case where the distance D0 is greater than the first set distance D1 and less than or equal to the second set distance D2, the identification function setting unit 22 sets the operational state of the information display device 1 in the function limitation mode (step S16). In the case where the distance D0 is over the second set distance D2, the identification function setting unit 22 sets the operational state of the information display device 1 in the specified function mode (step S17).

Subsequently, the display control unit 25 changes the layout of displaying the video content and the operation menu based on the operational state of the information display unit 1a and has the display unit 30 make the display. Further, the display control unit 25 adjusts the sizes of the characters, icons and pointer displayed on the display unit 30 based on the distance D0 (step S18).

The gesture identification unit 23 makes the gesture identification based on the motion pattern the operator 2's gesture shows and the identifiable gestures limited by the identification function setting unit 22 (step S19). The gesture identification unit 23 judges the operator 2's command content by referring to the gesture DB 40a. In this case, when the time necessary for the gesture identification exceeds a time limit or the operator 2 operates the information display device 1 by using a remote control or the like, the gesture identification unit 23 stops the gesture identification process (step S22).

When the command content of the operator 2's gesture has been judged, the function execution unit 24 executes a function based on the command content (step S20).

The information display device 1 judges whether the operator 2's operation by gesture ends or not (step S21). If the operator 2's operation exists (NO in the step S21), the gesture identification unit 23 makes the identification of the operator 2's gesture.

### <1-3> Effect

As described above, in the information display device 1 according to the first embodiment, the identifiable gestures are set so that the number of the identifiable gestures becomes small when the operator 2 is situated at a position far from the display unit 30 of the information display device 1 (e.g., position farther than the first set distance D1). As above, by the information display device 1 according to the first embodiment, when the operator 2 is situated at a position far from the display unit 30, erroneous identification of the operator 2's gesture can be made unlikely to occur by excluding gestures with a small body movement from the identifiable gestures, for example.

Further, in the information display device 1 according to the first embodiment, when the operator 2 is situated at a position far from the display unit 30 of the information display device 1 (e.g., position farther than the first set distance D1), the identifiable gestures are limited to gestures for functions of a high frequency of use. As above, by the information display device 1 according to the first embodiment, when the operator 2 is situated at a position far from the display unit 30, the identifiable gestures are reduced in number (e.g., limited to gestures regarding functions of a high frequency of use by the operator), by which erroneous identification of the operator 2's gesture can be made unlikely to occur.

Furthermore, in the information display device 1 according to the first embodiment, when the operator 2 is situated at a position far from the display unit 30 of the information display device 1 (e.g., position farther than the first set distance D1), the layout of the image displayed on the display unit 30 is changed and the operation menu including icons, characters, pointer, etc. is displayed in an enlarged view. As above, by the information display device 1 according to the first embodiment, even when the operator 2 is situated at a position far from the display unit 30, the operation menu is displayed in an enlarged view, which inhibits deterioration in viewability of the display content on the display unit 30 (visibility) for the operator 2 and easiness of operation (operability) for the operator 2.

In the above explanation, an example of switching the operational state by using the first set distance D1 and the second set distance D2 has been described. However, the information display device 1 may also employ a method using only one of the first and second set distances D1 and D2 or a method using three or more set distances.

### <2> Second Embodiment

In the first embodiment, when the operator 2's gesture is not identified (judged) by the information display device 1, the gesture identification process by the information display device 1 stops (the step S22 in FIG. 14) and the operation by gesture is performed again. In contrast, in the second embodiment, the fact that the gesture is not identified is displayed on the display unit 30. Incidentally, the configuration of the information display device in the second embodiment is the same as the configuration of the information display device 1 according to the first embodiment. Thus, FIG. 1 is also referred to in the following description of the second embodiment.

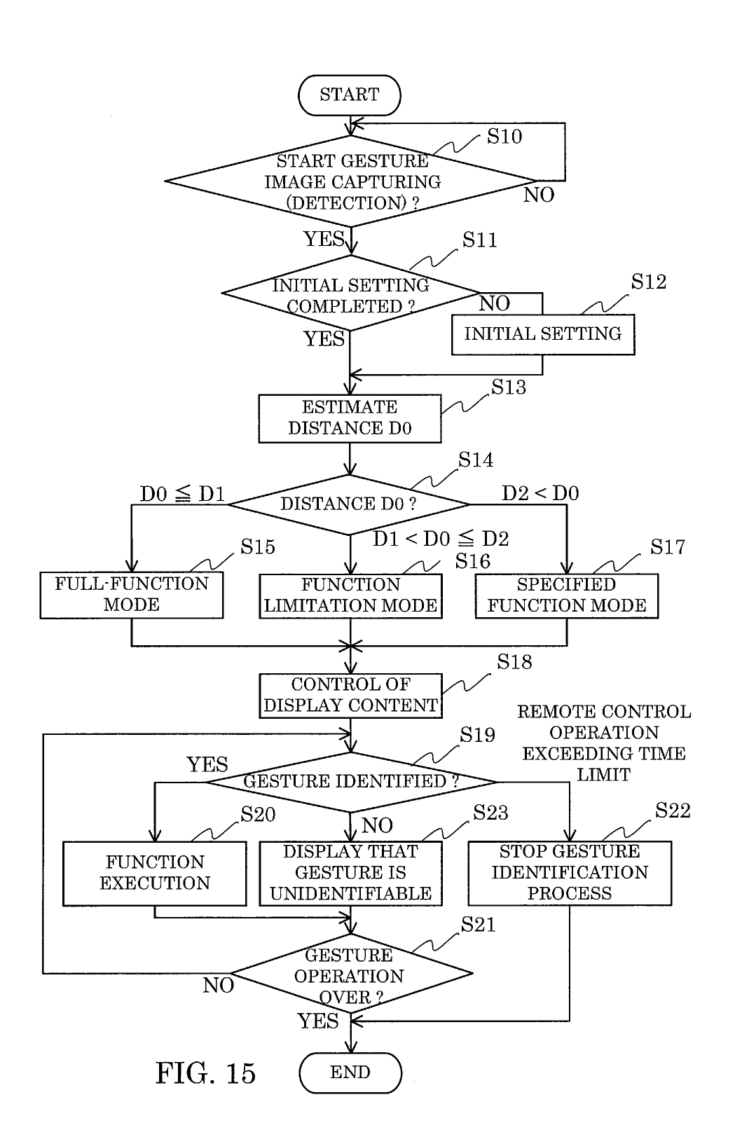

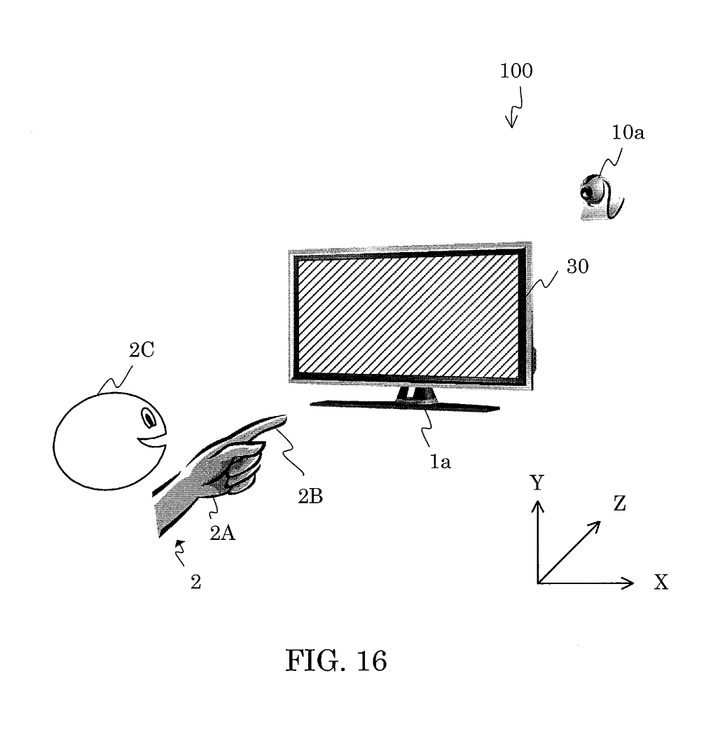

FIG. 15 is a flowchart showing the operation of the information display device according to the second embodiment of the present invention. In FIG. 15, processing steps identical with those shown in FIG. 14 are assigned the same reference characters as in FIG. 14.

The gesture identification unit 23 performs the gesture identification based on the motion pattern the operator 2's gesture shows and the identifiable gestures limited by the identification function setting unit 22 (step S19). In the second embodiment, when it is impossible to judge the command content from the operator 2's gesture, a process corresponding to the cause of the impossibility is performed. When the gesture performed by the operator 2 is judged to have no corresponding reference gesture included in the reference gestures stored in the gesture DB 40a, the gesture identification unit 23 notifies the display control unit 25 via the function execution unit 24 that the operator 2's gesture is unidentifiable. The display control unit 25 makes the display unit 30 display that the gesture is unidentifiable (step S23). When the time necessary for the identification of the gesture exceeds the time limit or when the operator 2 operates the information display device 1 by using the remote control or the like, the gesture identification unit 23 stops the gesture identification process (step S22).

As described above, in the second embodiment, when the gesture is not identified, the fact that the gesture is unidentifiable is displayed on the display unit 30. The display by the display unit 30 allows the operator 2 to grasp that the gesture was not identified. Accordingly, the operator 2 can select performing the gesture again or operating the information display device 1 by using a device such as the remote control. Consequently, even when the operator 2's gesture is not identified by the information display device 1, the information display device 1 can be prevented from being recognized by the operator 2 to have significantly deteriorated in operability.

Incidentally, except for the features described above, the information display device and information display method according to the second embodiment are equivalent to the device and method according to the first embodiment.

### <3> Third Embodiment

In the first embodiment, the gesture detection unit 10 was mounted on the main body of the information display device 1 (top part of the display unit 30). In a third embodiment, a description will be given of a case where the gesture detection unit is arranged at a position apart from an information display unit equipped with the display unit (display) 30.

FIG. 16 is a schematic diagram showing usage status of an information display device 100 according to the third embodiment of the present invention. In FIG. 16, components identical or corresponding to those shown in FIG. 1 (first embodiment) are assigned the same reference characters as in FIG. 1. As shown in FIG. 16, the information display device 100 includes an information display unit 1a, having the display unit 30, and a gesture detection unit 10a. The operator 2 operates the information display unit 1a by making a gesture. In the third embodiment, the gesture detection unit 10a is arranged at a position apart from the information display unit 1a, such as on a wall of a room.

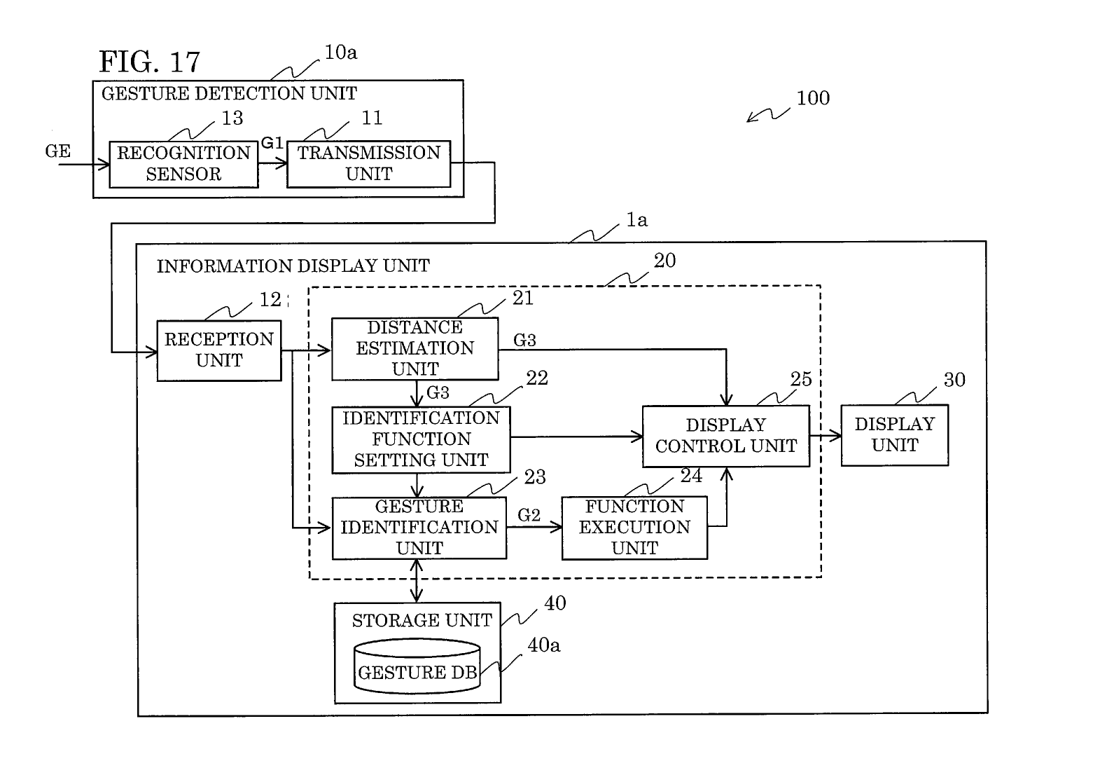

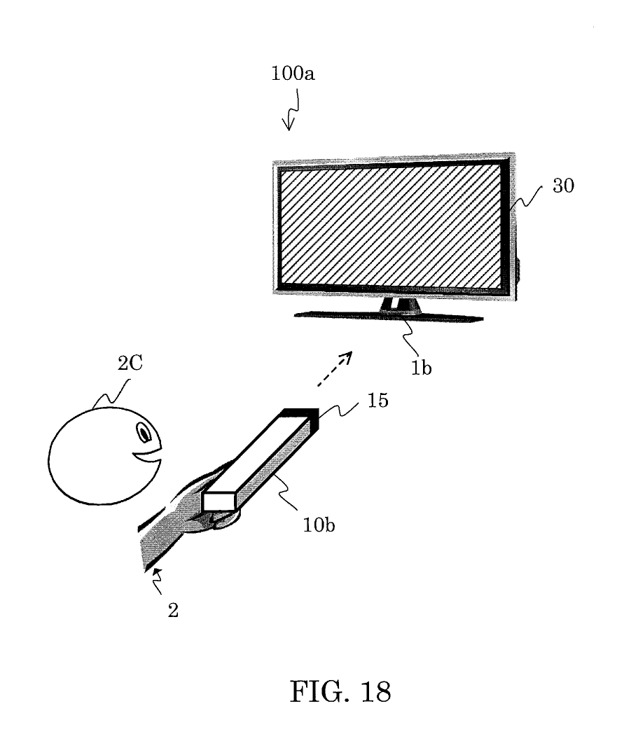

FIG. 17 is a block diagram schematically showing the configuration of the information display device 100 according to the third embodiment. In FIG. 17, components identical or corresponding to those shown in FIG. 2 (first embodiment) are assigned the same reference characters as in FIG. 2. As shown in FIG. 17, the information display device 100 includes the gesture detection unit 10a and the information display unit 1a.

The gesture detection unit 10a includes an image capturing unit 13 and a transmission unit 11. The image capturing unit 13 captures images of the operator 2's gesture GE and generates image data. The transmission unit 11 transmits the image data generated by the image capturing unit 13 to a reception unit 12 of the information display unit 1a.

The reception unit 12 of the information display unit 1a receives the image data transmitted from the transmission unit 11 of the gesture detection unit 10a and sends the received image data to the control unit 20. The method of communication between the transmission unit 11 and the reception unit 12 may be either wired communication or wireless communication such as Bluetooth (registered trademark), infrared data communication or Wi-Fi communication, for example.

In the third embodiment, the gesture detection unit 10a is fixed at a position where the operator 2's gesture can be detected. The information display unit 1a holds position information indicating the position where the gesture detection unit 10a is fixed (represented by XYZ coordinates, for example) and position information indicating the position of the display unit 30 of the information display unit 1a (represented by XYZ coordinates, for example). Therefore, the distance estimation unit 21 is capable of estimating (calculating) the distance between the operator 2 and the display unit 30 based on the aforementioned position information and the image data received from the reception unit 12. The gesture identification unit 23 is capable of detecting the motion pattern by analyzing the displacement of a part of the operator 2's body (detection region) included in the image data received from the reception unit 12.

As above, even in cases where the gesture detection unit 10a is arranged at a position apart from the information display unit 1a, the distance between the operator 2 and the display unit 30 can be estimated. Since the display content on the display unit 30 is changed depending on the estimated distance, the information display device 100 can maintain excellent operability when the operator 2 operates the information display unit 1a.

Further, even in cases where the information display unit 1a is not equipped with the gesture detection unit 10, the information display device according to the third embodiment can be formed by combining the information display unit 1a with the gesture detection unit 10 by updating the software of the information display unit 1a. As above, the information display device according to the third embodiment is applicable also to conventional information display devices.

Incidentally, except for the features described above, the information display device and information display method according to the third embodiment are equivalent to the device and method according to the first or second embodiment.

### <4> Fourth Embodiment

In the third embodiment, the description was given of a case where the gesture detection unit 10a is fixed at a predetermined position and the object of detection (image capturing) by the gesture detection unit 10a is the operator 2. In the fourth embodiment, a description will be given of a case where an operating device as a gesture detection unit is attached to the body of the operator 2 performing the gesture (e.g., the operator holds the operating device in hand) and the object of the detection (image capturing) by the operating device as the gesture detection unit is the display unit of the information display device, for example.

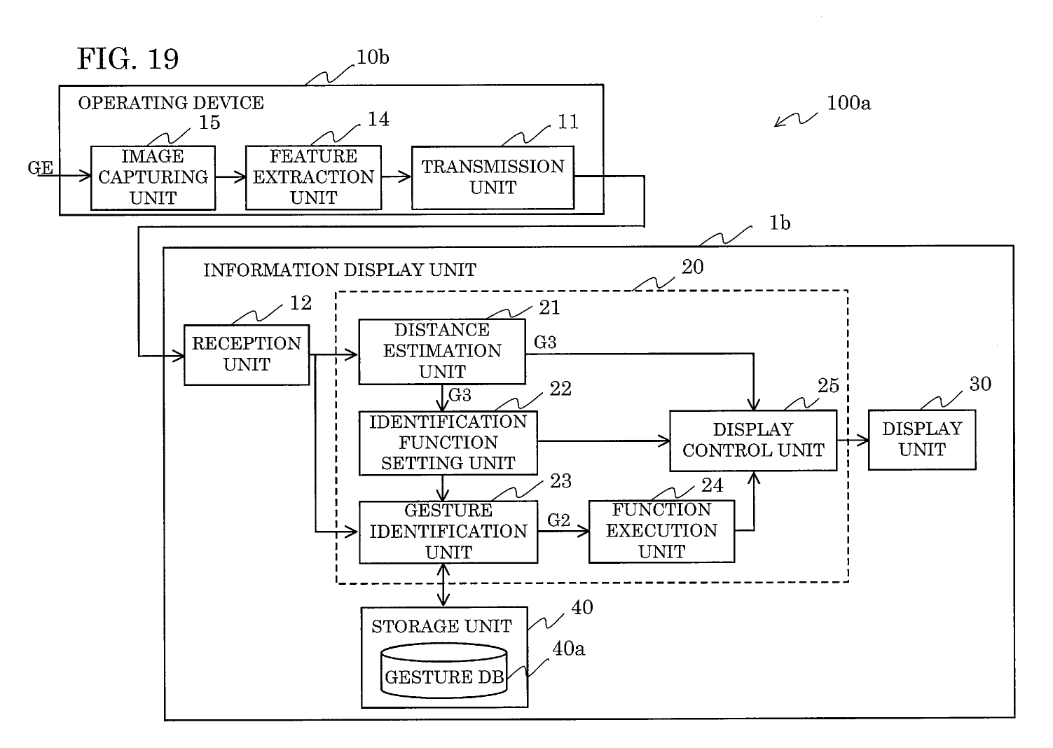

FIG. 18 is a schematic diagram showing usage status of an information display device 100a according to the fourth embodiment of the present invention. In FIG. 18, components identical or corresponding to those shown in FIG. 16 (third embodiment) are assigned the same reference characters as in FIG. 16. As shown in FIG. 18, the information display device 100a includes an information display unit 1b, having the display unit 30, and an operating device 10b as the gesture detection unit. The operator 2 inputs an operation signal to the reception unit 12 (shown in FIG. 19 which will be explained later) of the information display unit 1b by performing a gesture with the operating device 10b attached to the operator 2's body (e.g., held in hand). The operator 2 inputs the operation signal to the information display unit 1b by a gesture such as moving (swinging) the operating device 10b leftward, rightward, upward or downward or drawing a character or mark in the air with the operating device 10b, for example. The shape and size of the operating device 10b are not limited to those shown in FIG. 18; the operating device 10b may be in a different shape.

FIG. 19 is a block diagram schematically showing the configuration of the information display device 100a according to the fourth embodiment. In FIG. 19, components identical or corresponding to those shown in FIG. 17 (third embodiment) are assigned the same reference characters as in FIG. 17.

The operating device 10b includes an image capturing unit 15 as a recognition sensor, a feature extraction unit 14, and the transmission unit 11. The image capturing unit 15 generates image data by capturing images of a region as the subject including the information display unit 1b while the operator 2 performs a gesture. The image capturing unit 15 is an RGB camera or a ToF sensor, for example. The RGB camera can be a camera mounted on a personal digital assistant or a mobile information terminal such as a smartphone in which software for implementing the function of communicating with the information display unit 1b has been installed.

The feature extraction unit 14 extracts features of the gesture performed by the operator 2 from the image data generated by the image capturing unit 15. The features of the gesture are extracted as motion vectors of the operating device 10b (locus of the motion of the operating device 10b) by analyzing the displacement of an object, as a certain image-captured object included in the image data, in multiple pieces of still image data arranged in the order of time or video image data. The feature extraction unit 14 can use the display unit 30 of the information display unit 1b as the object included in the image data generated by the image capturing unit 15. The feature extraction unit 14 sends information regarding the generated image data, the features of the gesture and the region of the display unit 30 to the transmission unit 11.

The transmission unit 11 transmits the information regarding the generated image data, the features of the gesture and the region of the display unit 30 of the information display unit 1b towards the reception unit 12 of the information display unit 1b.

As described above, the information display device 100a according to the fourth embodiment is capable of estimating the distance between the operator 2 and the display unit 30 when the operator 2 performs a gesture while holding the operating device 10b in hand. Since the display content is changed depending on the estimated distance, the information display device 100a can maintain operability for the operator operating the information display device.

Further, similarly to the third embodiment, even in cases where the information display unit 1b is not equipped with the image capturing unit 15, the information display device according to the fourth embodiment can be formed by combining the information display unit 1b with the image capturing unit 15 and updating the software of the information display unit 1b. As above, the information display device according to the fourth embodiment is applicable to conventional information display devices.

Incidentally, except for the features described above, the information display device and information display method according to the fourth embodiment are equivalent to the device and method according to the third embodiment.

<5> Fifth Embodiment

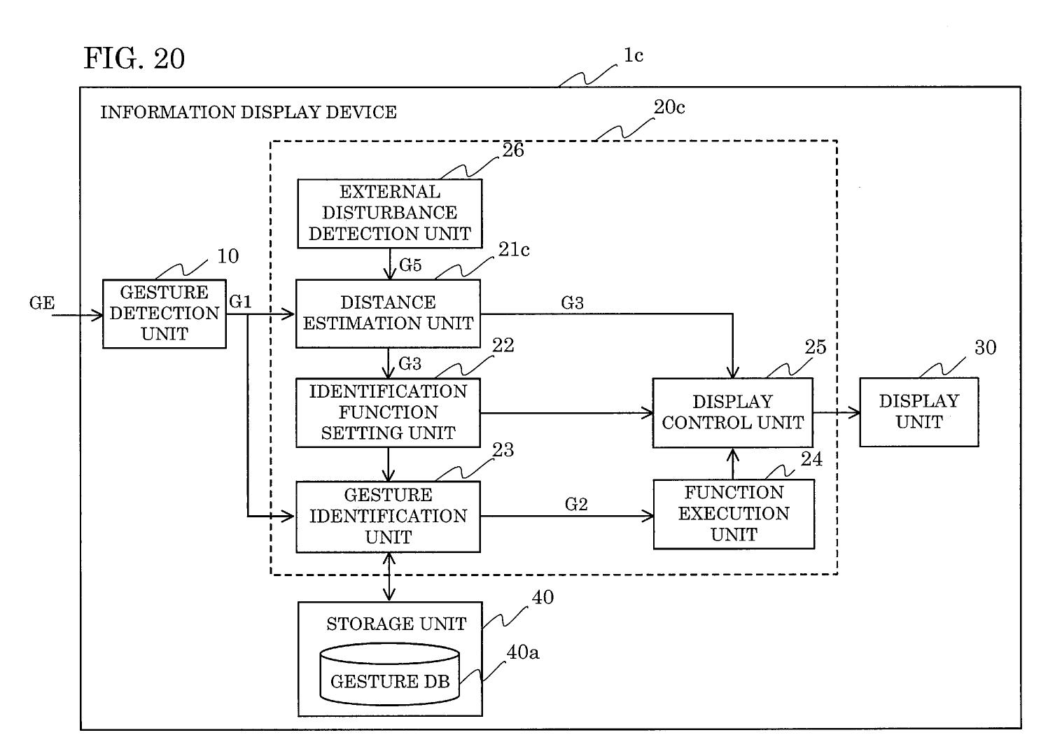

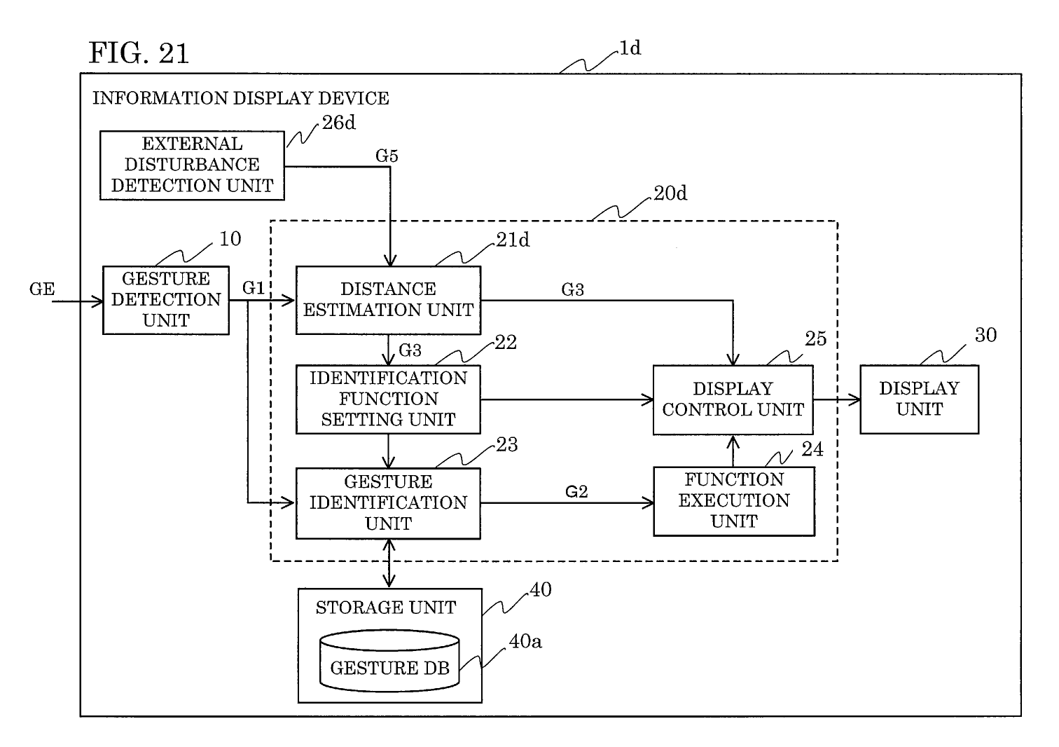

In the first to fourth embodiments, when the image data generated by the information display device 1 is influenced by external disturbance such as vibration, illumination and natural light (external light) due to the environment of the place where the operator 2 performs the gesture operation (e.g., condition of illumination and condition of natural light) and the environment of the place where the information display device 1 (or the information display unit 1a or 1b) is installed (e.g., condition of illumination and condition of natural light), the possibility of erroneous recognition of the operator 2's gesture operation by the information display device 1 increases. In contrast, an information display device 1c according to a fifth embodiment includes an external disturbance detection unit 26, thereby inhibits the erroneous recognition due to the influence of external disturbance, and improves the operability of the information display device 1c operated by the gesture operation. In the following, the information display device 1c according to the fifth embodiment and an information display device 1d according to a modification of the fifth embodiment will be described with reference to FIGS. 20 and 21.

FIG. 20 is a block diagram schematically showing the configuration of the information display device 1c according to the fifth embodiment of the present invention. In FIG. 20, components identical or corresponding to those shown in FIG. 2 (first embodiment) are assigned the same reference characters as in FIG. 2. As shown in FIG. 20, the information display device 1c according to the fifth embodiment differs from the information display device 1 according to the first embodiment in that a control unit 20c includes the external disturbance detection unit 26 and in the processing performed by a distance estimation unit 21c of the control unit 20c.

The external disturbance detection unit 26 detects a movement in the multiple frames of images (multiple pieces of image data) G1 generated by the image capturing by the gesture detection unit 10, and when a regular movement in a certain predetermined period is included in the detected movement, judges the regular movement as the external disturbance (e.g., vibration, change in the condition of illumination, change in the condition of natural light, or the like) and generates filter information G5 based on the judgment (information to be used for a process for removing the influence of the external disturbance).

The filter information G5 generated by the external disturbance detection unit 26 is sent to the distance estimation unit 21c. The distance estimation unit 21c compensates for the movement in the multiple frames of images (multiple pieces of image data) G1 based on the filter information G5 received from the gesture detection unit 10. More specifically, the distance estimation unit 21c generates multiple frames of images (multiple pieces of image data) G3 with no influence of the external disturbance (or with reduced influence of the external disturbance) by removing components of the regular movement as the influence of the external disturbance from the multiple frames of images (multiple pieces of image data) G1.

FIG. 21 is a block diagram schematically showing the configuration of the information display device 1d according to the modification of the fifth embodiment. In FIG. 21, components identical or corresponding to those shown in FIG. 20 are assigned the same reference characters as in FIG. 20. As shown in FIG. 21, the information display device 1d differs from the information display device 1c according to the fifth embodiment in including an external disturbance detection unit 26d as a component outside a control unit 20d. The control unit 20d of the information display device 1d performs the same control as the control unit 20c of the information display device 1c.

The external disturbance detection unit 26d detects a movement in the multiple frames of images (multiple pieces of image data) G1 generated by the image capturing by the gesture detection unit 10, and when a regular movement in a certain predetermined period is included in the detected movement, judges the regular movement as the external disturbance (e.g., acceleration, vibration, inclination, change in the condition of illumination, change in the condition of natural light, or the like) and generates filter information G5 based on the judgment (information to be used for the process for removing the influence of the external disturbance). As above, the external disturbance detection unit 26d is a unit newly provided outside the control unit 20d, and can be, for example, an acceleration sensor, a vibration sensor, an inclination sensor, an optical sensor or the like capable of detecting the external disturbance such as acceleration, vibration, inclination, the condition of illumination, the condition of natural light, or the like.

The filter information G5 generated by the external disturbance detection unit 26d is sent to the distance estimation unit 21d. The distance estimation unit 21d compensates for the movement in the multiple frames of images (multiple pieces of image data) G1 based on the filter information G5 received from the gesture detection unit 10. More specifically, the distance estimation unit 21d generates multiple frames of images (multiple pieces of image data) G3 with no influence of the external disturbance (or with reduced influence of the external disturbance) by removing components of the regular movement as the influence of the external disturbance from the multiple frames of images (multiple pieces of image data) G1.

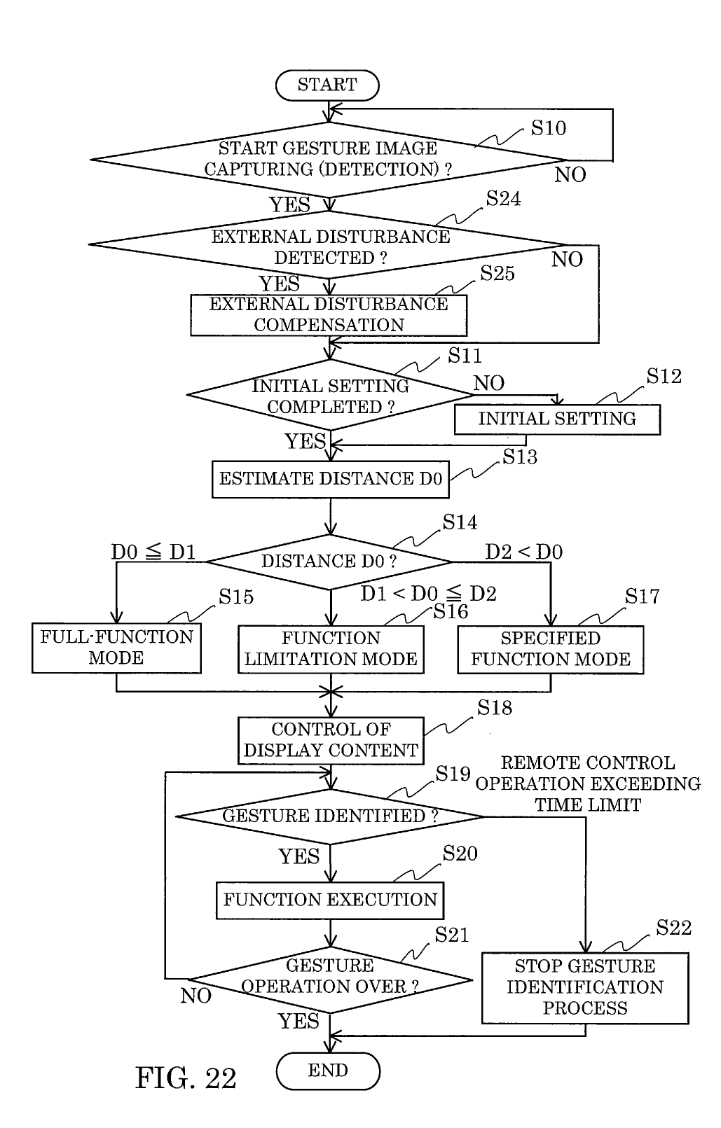

FIG. 22 is a flowchart showing the operation of the information display devices 1c and 1d in the fifth embodiment. In FIG. 22, processing steps identical with those shown in FIG. 14 (first embodiment) are assigned the same reference characters as in FIG. 14. The process shown in FIG. 22 differs from the process shown in FIG. 14 in including steps S24 and S25. A principal part of the operation of the information display device 1c will be described below with reference to FIG. 22.

As shown in FIG. 22, the gesture detection unit 10 starts the gesture image capturing (detection) triggered by a predetermined gesture performed by the operator 2 (step S10).

Subsequently, the external disturbance detection unit 26 performs an external disturbance detection process (step S24). When external disturbance is detected by the external disturbance detection unit 26 (YES in the step S24), the distance estimation unit 21c compensates for the influence of the external disturbance by removing components of a regular movement due to the external disturbance from the image data G1 (step S25). When no external disturbance is detected by the external disturbance detection unit 26 (NO in the step S24), the distance estimation unit 21c advances the process to the step S11 without performing the process of compensating for the influence of the external disturbance. The processing from the step S11 is the same as the processing shown in FIG. 14 (first embodiment).

Incidentally, while the external disturbance detection (step S24) is performed after starting the gesture detection (step S10) in the flowchart shown in FIG. 22, it is also possible to start the gesture detection (step S10) after performing the external disturbance detection (step S24).

Except for the features described above, the information display device 1c and information display method according to the fifth embodiment are equivalent to the devices and methods according to the first to fourth embodiments. Except for the features described above, the information display device 1d and information display method according to the modification of the fifth embodiment are equivalent to the devices and methods according to the first to fourth embodiments.

By the information display devices 1c and 1d and the information display methods according to the fifth embodiment, the influence of the external disturbance can be lessened, and thus the accuracy of the gesture recognition can be increased.

### <6> Sixth Embodiment

In the first to fifth embodiments, the description was given of configurations for detecting the gesture with the gesture detection unit 10 and measuring the distance without identifying the operator 2. In contrast, in a sixth embodiment, a description will be given of a case where an operator recognition unit 27 identifies (recognizes) the operator 2 performing the gesture operation from the images (image data) G1 generated by the gesture detection unit 10 and the distance is measured by using previously registered size information on the operator 2's body part.

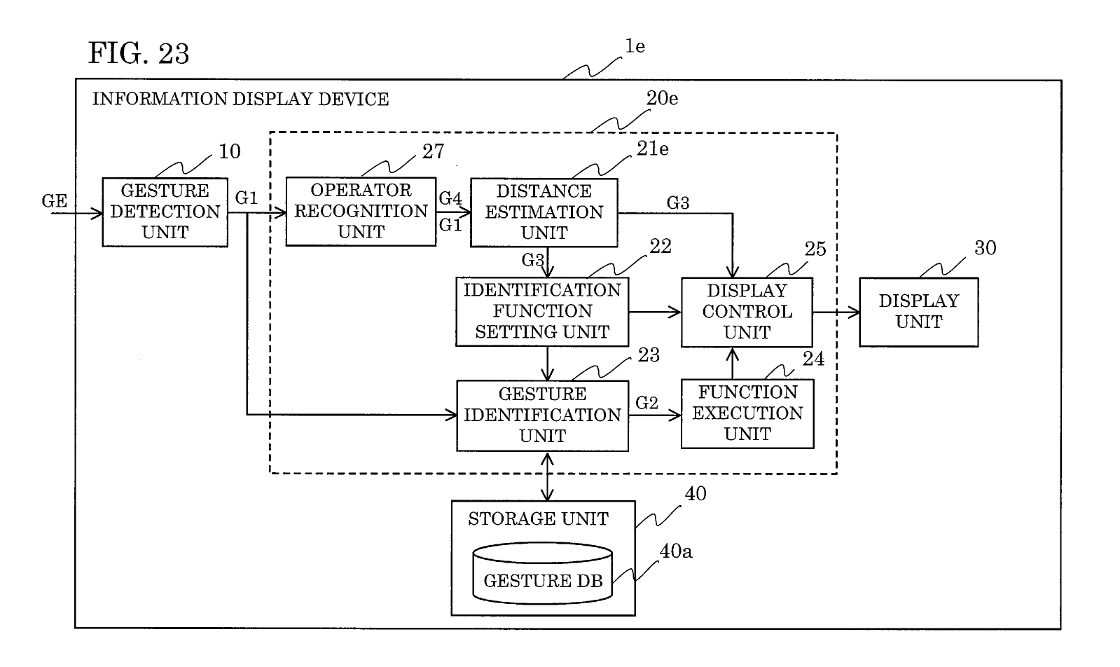

FIG. 23 is a block diagram schematically showing the configuration of an information display device 1e according to the sixth embodiment of the present invention. In FIG. 23, components identical or corresponding to those shown in FIG. 2 (first embodiment) are assigned the same reference characters as in FIG. 2. As shown in FIG. 23, the information display device 1e differs from the information display device 1 according to the first embodiment in that a control unit 20e includes the operator recognition unit 27 and in the processing performed by a distance estimation unit 21e of the control unit 20e.

The operator recognition unit 27 previously stores a face image (face image data) of the operator 2 and attribute information on the operator 2 while associating (linking) them with each other when the initial setting information (the predetermined first set distance D1 and second set distance D2) is stored in the identification function setting unit 22. The attribute information stored in the operator recognition unit 27 includes information for judging attributes of the operator 2, such as adult or child, male or female, age range (age), and nationality. The attribute information may be either information estimated from a body part captured in an image generated by the image capturing by the gesture detection unit 10, such as the face, physique, hand size and skin color registered at the time of initial setting, or information selected by the operator 2 at the time of setting.

The display content and the sizes of characters, icons and pointer controlled by the display control unit 25 can be changed according to the attribute information on the operator 2 stored in the operator recognition unit 27 and the distance information estimated by the distance estimation unit 21e.

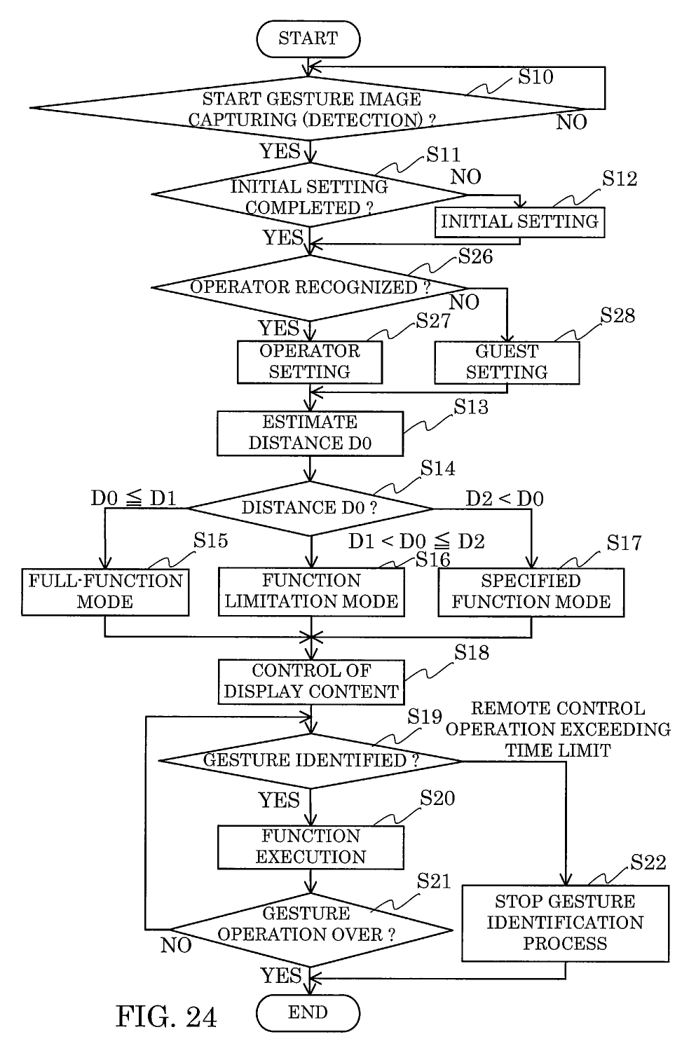

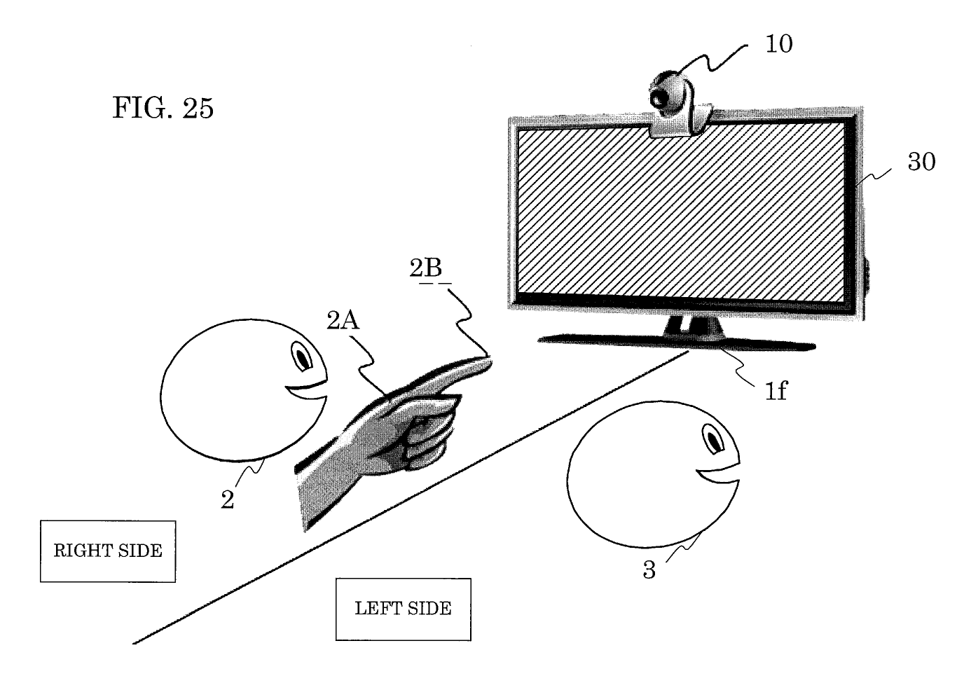

FIG. 24 is a flowchart showing the operation of the information display device 1e according to the sixth embodiment. In FIG. 24, processing steps identical with those shown in FIG. 14 are assigned the same reference characters as in FIG. 14. The process shown in FIG. 24 differs from the process shown in FIG. 14 in including steps S26, S27 and S28. A principal part of the operation of the information display device 1e will be described below with reference to FIG. 24.

As shown in FIG. 24, the gesture detection unit 10 starts the gesture image capturing (detection) triggered by a predetermined gesture performed by the operator 2 (step S10). Subsequently, the information display device 1e judges whether the initial setting shown in FIG. 13, that is, the setting of the first set distance D1 and the second set distance D2 (steps S1 and S2), has been completed (step S11). If the initial setting has not been made, the information display device 1e makes the initial setting shown in FIG. 13 (step S12).

Subsequently, when the gesture detection is started and the initial setting including the operator registration is confirmed to have been made (steps S10, S11 and S12), the operator recognition unit 27 performs the operator recognition process (step S26). When the operator 2 is recognized (YES in the step S26), the operator recognition unit 27 makes a setting of the operator 2 and sends display setting information G4 based on the setting of the operator 2 and the image data G1 to the distance estimation unit 21e (step S27). When the operator 2 cannot be recognized (NO in the step S26), the operator recognition unit 27 sets guest setting information and sends the guest setting information and the image data G1 to the distance estimation unit 21e (step S28).

Subsequently, the distance estimation unit 21e estimates the distance D0 between the operator 2 and the gesture detection unit 10 (or the display unit 30) (step S13). The processing after the step S13 in FIG. 24 is the same as the processing after the step S13 shown in FIG. 14 (first embodiment).

As above, identification information on the operator 2 can also be displayed on the display unit 30 by performing the process of identifying (determining) the operator 2 with the operator recognition unit 27 and performing the process in the distance estimation unit 21e based on the attribute information on the operator 2 and the image data G1. In this case, even when there are multiple people at positions at the same distance from the information display device 1e, which one of the people has been recognized as the operator 2 by the information display device 1e can be indicated to the operator 2 himself/herself. Accordingly, the operator 2 can obtain excellent operability in the gesture operation of the information display device 1e.

By the information display device 1e and information display method according to the sixth embodiment, even when there are multiple people, the gesture recognition can be performed while identifying the operator 2, by which the accuracy of the gesture recognition can be increased.

Except for the features described above, the information display device 1e and information display method according to the sixth embodiment are equivalent to the devices and methods according to the first to fourth embodiments.

### <7> Seventh Embodiment

In the first to fourth embodiments, the distance estimation unit 21 estimates the distance D0 between the operator 2 and the gesture detection unit 10 (or the display unit 30) based on the gesture information G1 outputted from the gesture detection unit 10, but does not judge whether the operator 2 is situated on the left side or on the right side of the gesture detection unit 10 (or the display unit 30). In contrast, as shown in FIG. 25, an information display device 1f according to a seventh embodiment judges not only the distance D0 between the operator 2 and the gesture detection unit 10 (or the display unit 30) but also whether the operator 2 is situated on the left side or on the right side of a front center position of the gesture detection unit 10 (or the display unit 30). Namely, the information display device 1f has a function of judging whether the operator 2 is situated on the left side or the right side of the front center position of the gesture detection unit 10 when there are two people (the operator 2 and another person 3).

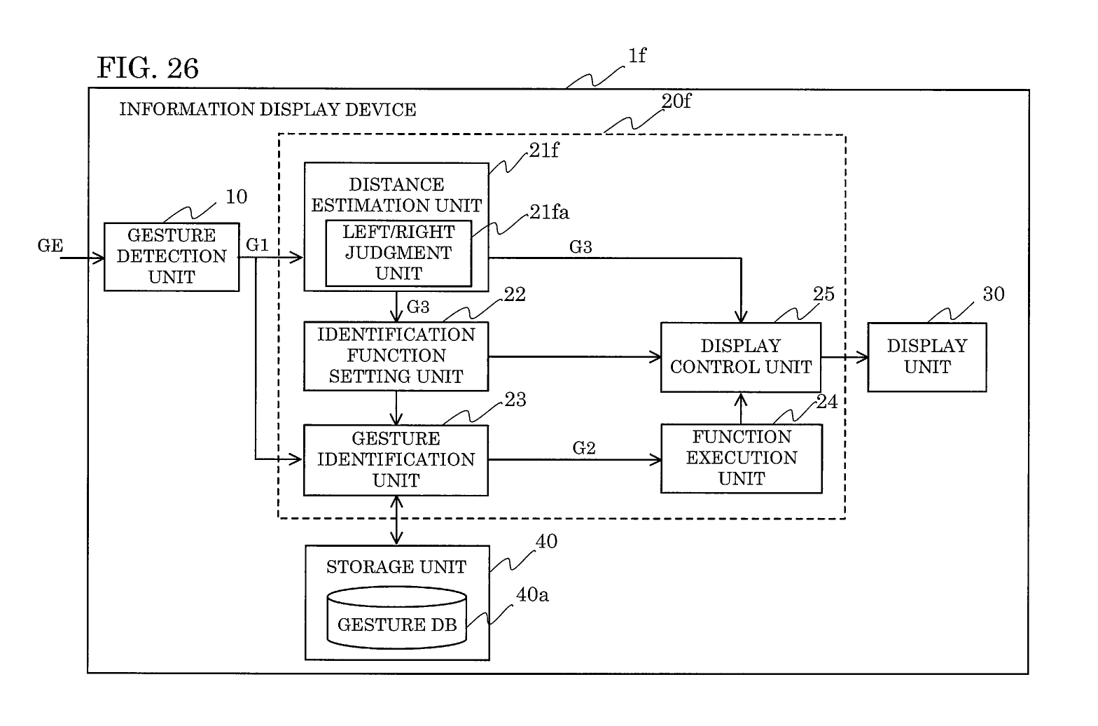

FIG. 26 is a block diagram schematically showing the configuration of the information display device 1f according to the seventh embodiment of the present invention. In FIG. 26, components identical or corresponding to those shown in FIG. 2 (first embodiment) are assigned the same reference characters as in FIG. 2. As shown in FIG. 23, the information display device 1e differs from the information display device 1 according to the first embodiment in that a distance estimation unit 21f of a control unit 20f includes a left/right judgment unit 21fa and in the processing performed by the distance estimation unit 21f of the control unit 20f.

The left/right judgment unit 21fa judges whether a detection region (where the operator 2 is detected) in each frame image captured and generated by the gesture detection unit 10, namely, the operator 2, is situated in a region on the left side or in a region on the right side when the image is divided into two regions on the left side and the right side. By this process, the left/right judgment unit 21fa can judge in which of the left-side region or the right-side region, obtained by dividing the frame image into the left side and the right side, the operator 2 is situated.

By using the position of the gesture detection unit 10 or the display unit 30 as the reference, the left/right judgment unit 21fa is capable of measuring the distance from the gesture detection unit 10 to the operator 2 and judging whether the operator 2 is situated on the left side or the right side in the case where the frame image is divided into the left side and the right side. For example, the left/right judgment unit 21fa is capable of judging whether the operator 2 in an in-car space is the driver seated on the driver seat (on the left side as viewed from the gesture detection unit 10 in cases of a car with the steering wheel on the right side), a person seated on the passenger seat (on the right side as viewed from the gesture detection unit 10 in cases of a car with the steering wheel on the right side), or a person seated on the rear seat (on the right side or the left side of the rear seat as viewed from the gesture detection unit 10).

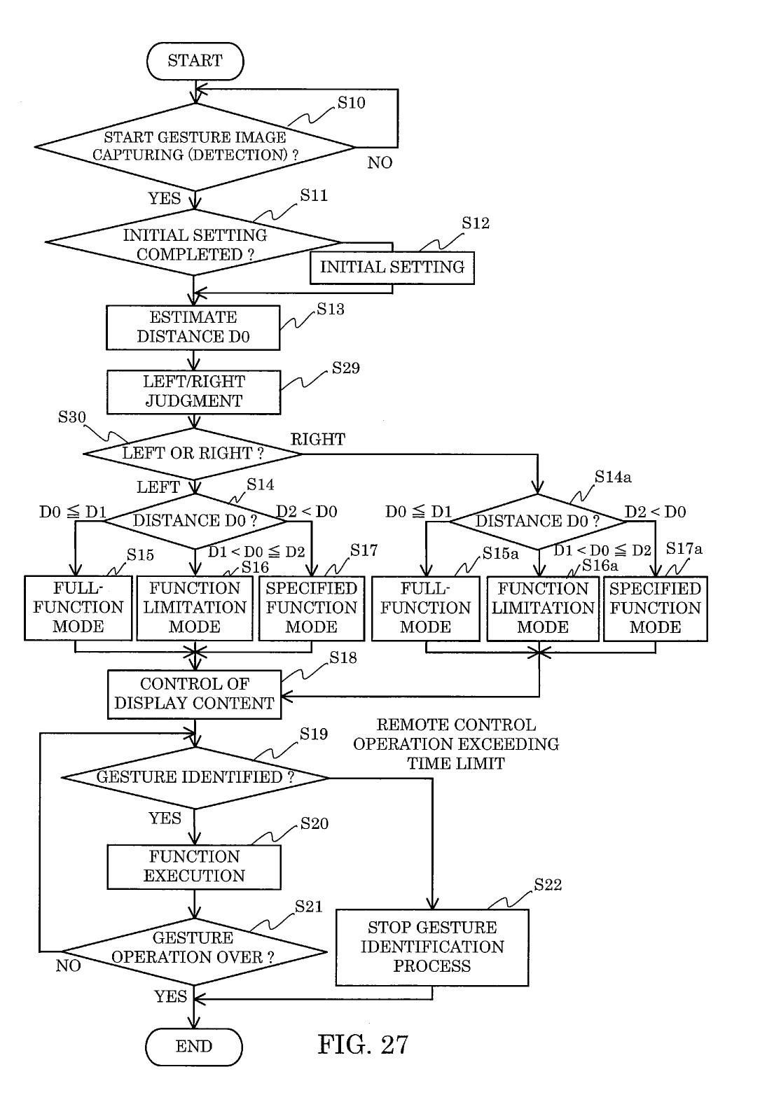

FIG. 27 is a flowchart showing the operation of the information display device according to the seventh embodiment of the present invention. In FIG. 27, processing steps identical with those shown in FIG. 14 are assigned the same reference characters as in FIG. 14. The process shown in FIG. 27 differs from the process shown in FIG. 14 in including steps S29 and S30 and in performing either a process of steps S14, S15, S16 and S17 or a process of steps S14a, S15a, S16a and S17a depending on judgment result of the step S30. A principal part of the operation of the information display device 1f will be described below with reference to FIG. 27.

As shown in FIG. 27, the gesture detection unit 10 starts the gesture image capturing (detection) triggered by a predetermined gesture performed by the operator 2 (step S10). Subsequently, the information display device 1f judges whether the initial setting shown in FIG. 13, that is, the setting of the first set distance D1 and the second set distance D2 (steps S1 and S2), has been completed (step S11). If the initial setting has not been made, the information display device 1 makes the initial setting shown in FIG. 13 (step S12).

Subsequently, the distance estimation unit 21f estimates the distance D0 between the operator 2 and the gesture detection unit 10 (or the display unit 30) (step S13). After the estimation of the distance D0 (step S13), the left/right judgment unit 21fa judges whether the operator 2 is situated on the left side or the right side as viewed from the display unit 30 based on a frame image captured and generated by the gesture detection unit 10a (step S29).

When the judgment can be made on whether the operator 2 is situated on the left side or the right side as viewed from the display unit 30, the information display device 1f shifts to a mode on the left side based on the distance D0 or a mode on the right side based on the distance D0 (step S30). Incidentally, when the judgment cannot be made on whether the operator 2 is situated on the left side or the right side as viewed from the display unit 30, a predetermined process (e.g., the steps S14-S17 or the steps S14a-S17a) may be selected and the fact that the judgment cannot be made may be reported to the display control unit 25 and displayed on the display unit 30. Further, the fact that the operator 2 is situated on the left side or the right side as viewed from the display unit 30, or the fact that the judgment cannot be made, may be displayed on the display unit 30.

In the information display device 1f according to the seventh embodiment, the distance estimation unit 21f includes the left/right judgment unit 21fa, and the display content controlled by the display control unit 25 can be switched by, for example, judging whether the operator 2 is an operator 2 seated on the driver seat or an operator 2 seated on the passenger seat. For example, the information display device 1f may display all the operations allowing for the gesture operation on the display unit 30 in the case where the operator 2 is a person seated on the driver seat, and display only functions irrelevant to safety (limited functions) among the operations allowing for the gesture operation on the display unit 30 in the case where the operator 2 is a person seated on the passenger seat.

Subsequently, the distance estimation unit 21f estimates the distance D0 between the operator 2 and the gesture detection unit 10 (or the display unit 30) (step S13). Subsequently, when the distance estimation unit 21f judges that the operator 2 is situated on the left side in the steps S29 and S30, the information display device 1f advances the process to the step S15 if the distance D0 is less than or equal to the first set distance D1, advances the process to the step S16 if the distance D0 is greater than the first set distance D1 and less than or equal to the second set distance D2, or advances the process to the step S17 if the distance D0 is over the second set distance D2 (step S14). When the distance estimation unit 21f judges that the operator 2 is situated on the right side in the steps S29 and S30, the information display device 1f advances the process to the step S15a if the distance D0 is less than or equal to the first set distance D1, advances the process to the step S16a if the distance D0 is greater than the first set distance D1 and less than or equal to the second set distance D2, or advances the process to the step S17a if the distance D0 is over the second set distance D2 (step S14a). Incidentally, the steps S15a, S16a and S17a are equivalent to the steps S15, S16 and S17 except that the operator 2 is situated on the right side.

By the information display device 1f and information display method according to the seventh embodiment, it is possible to judge in which direction the operator 2 is situated as viewed from the information display device 1f, and the contents of the operation (the display content on the display unit 30) can be switched depending on the judged direction (e.g., the left side or the right side).

Except for the features described above, the information display device 1f and information display method according to the seventh embodiment are equivalent to the devices and methods according to the first to fourth embodiments.

### <8> Modifications

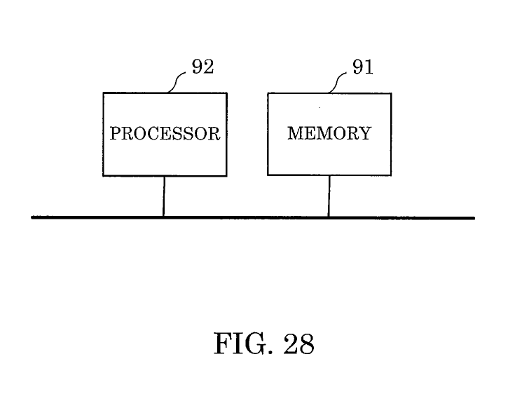

FIG. 28 is a hardware configuration diagram showing the configuration of a modification of the information display devices according to the first to seventh embodiments described above. The information display device according to each of the first to seventh embodiments can be implemented by use of a memory 91 as a storage device for storing a program as software and a processor 92 as an information processing unit for executing the program stored in the memory 91 (e.g., implemented by a computer). In this case, the storage unit 40 shown in FIG. 2, FIG. 17 and FIG. 19 correspond to the memory 91 in FIG. 28, and the control unit 20 shown in FIG. 2, FIG. 17 and FIG. 19 correspond to the processor 92 in FIG. 28 for executing the program. It is also possible to implement part of the control unit 20 shown in FIG. 2, FIG. 17 or FIG. 19 by the memory 91 and the processor 92 in FIG. 28. Incidentally, the present invention can be modified within the range not departing from the content of the present invention.

It is possible to combine some of the configurations of the information display devices according to the first to seventh embodiments described above. For example, it is possible to freely combine the external disturbance inhibition function in the fifth embodiment, the function of determining the distance by using the operator recognition result in the sixth embodiment, and the function of switching the display content depending on the direction of the operator (on the left side or the right side as viewed from the device) in the seventh embodiment.

### INDUSTRIAL APPLICABILITY

The present invention is applicable to a variety of information display devices such as television sets, PCs, car navigation systems, rear seat entertainment systems (RSEs), and digital signage systems installed in facilities like stations and airports, for example.

### DESCRIPTION OF REFERENCE CHARACTERS

1, 1c, 1d, 1e, 1f: information display device, 1a, 1b: information display unit, 2: operator, 10, 10a: gesture detection unit, 10b: operating device, 11: transmission unit, 12: reception unit, 14: feature extraction unit, 20, 20c, 20d, 20e, 20f: control unit, 21, 21c, 21d, 21e, 21f: distance estimation unit, 21fa: left/right judgment unit, 22: identification function setting unit, 23: gesture identification unit, 24: function execution unit, 25: display control unit, 26: external disturbance detection unit, 27: operator recognition unit, 30: display unit, 31: screen.

1. An information display device comprising:
a display control unit that makes a display unit display, a result obtained by identifying a person as an operator among a plurality of persons;
a gesture detection unit that generates gesture information based on a gesture performed by the operator;
a gesture identification unit that makes identification of the gesture based on the gesture information generated by the gesture detection unit and outputs a signal based on result of the identification;
an identification function setting unit that stores a first set distance previously set and sets gestures identifiable by the gesture identification unit so that a number of gestures identifiable by the gesture identification unit when a distance between the operator and the display unit is over the first set distance is smaller than the number of gestures identifiable by the gesture identification unit when the distance is less than or equal to the first set distance;
an operator recognition unit that stores a face image of the operator and attribute information on the operator while associating the face image and the attribute information with each other and identifies the operator; and
a distance estimation unit that estimates the distance based on the attribute information on the operator identified by the operator recognition unit and the gesture information.

2. The information display device according to claim 1, wherein the display control unit changes the information displayed on the display unit depending on the distance.

3. The information display device according to claim 2, wherein the display control unit changes layout of an image displayed on the display unit depending on the distance.

4. The information display device according to claim 2, wherein the display control unit changes size of at least characters, icons or pointer displayed on the display unit depending on the distance.

5. The information display device according to claim 1, wherein the display control unit causes part of the information displayed on the display unit when the distance was less than or equal to the first set distance to be displayed in an enlarged view when the distance is over the first set distance.

6. The information display device according to claim 5, wherein the display control unit causes at least characters, icons or pointer displayed on the display unit when the distance was less than or equal to the first set distance to be displayed in an enlarged view when the distance is over the first set distance.

7. The information display device according to claim 1, wherein the display control unit changes the information displayed on the display unit in response to the identifiable gestures set by the identification function setting unit.

8. The information display device according to claim 1, wherein the identification function setting unit is configured to:
previously store a second set distance greater than the first set distance, and
set the gestures identifiable by the gesture identification unit so that the number of gestures identifiable by the gesture identification unit when the distance is over the second set distance previously set is smaller than the number of gestures identifiable by the gesture identification unit when the distance is less than or equal to the second set distance.

9. The information display device according to claim 8, wherein when the distance is over the second set distance, the display control unit makes the display unit display information different from the information displayed on the display unit when the distance was over the first set distance and less than or equal to the second set distance.

10. The information display device according to claim 1, wherein:
the gesture detection unit performs image capturing of the operator's gesture, and
the gesture information is image data generated by the image capturing.

11. The information display device according to claim 1, wherein the gesture detection unit includes an operating device that is held by the operator's body, performs image capturing of the display unit, and transmits image data generated by the image capturing.

12. The information display device according to claim 10, wherein the distance estimation unit estimates the distance between the operator and the display unit based on the image data outputted from the gesture detection unit.

13. The information display device according to claim 10, wherein:
the distance estimation unit includes a left/right judgment unit that judges whether the operator is situated on a left side or a right side with respect to a center of the display unit, and
the display control unit switches display content on the display unit based on result of the judgment by the left/right judgment unit.

14. The information display device according to claim 10, further comprising an external disturbance detection unit that detects a movement in multiple frames of images generated by the image capturing by the gesture detection unit, and when a regular movement in a certain predetermined period is included in the detected movement, judges the regular movement as external disturbance and generates filter information based on the judgment,
wherein the distance estimation unit compensates for the movement in the multiple frames of images based on the filter information.

15. (canceled)

16. The information display device according to claim 1, further comprising a storage unit that stores reference gesture information indicating a plurality of reference gestures and command contents corresponding to the plurality of reference gestures as a gesture database,
wherein the gesture identification unit compares the gesture information outputted from the gesture detection unit with the reference gesture information stored in the storage unit and makes the identification of the gesture based on result of the comparison.

17. The information display device according to claim 1, further comprising a function execution unit that executes a function based on the result of the identification by the gesture identification unit.

18. The information display device according to claim 17, wherein the function execution unit outputs a signal based on the result of the identification by the gesture identification unit to the display control unit.

19. The information display device according to claim 1, further comprising the display unit.

20. An information display method executed by an information display device that makes a display unit display information, comprising:
a display control step of making a display unit display, a result obtained by identifying a person as an operator among a plurality of persons;
a gesture detection step of generating gesture information based on a gesture performed by the operator;
a gesture identification step of making identification of the gesture based on the gesture information generated in the gesture detection step and generating a signal based on result of the identification;
an identification function setting step of setting gestures identifiable in the gesture identification step so that the number of gestures identifiable in the gesture identification step when a distance between the operator and the display unit is over a first set distance previously set is smaller than the number of gestures identifiable in the gesture identification step when the distance is less than or equal to the first set distance;
an operator recognition step of storing a face image of the operator and attribute information on the operator while associating the face image and the attribute information with each other and identifies the operator; and
a distance estimation step of estimating the distance based on the attribute information on the operator identified by the operator recognition unit and the gesture information.
